(19) United States
(12) Patent Application Publication
(10) Pub. No.: US 2026/0253811 A1
(43) Pub. Date: Aug. 27, 2026

(54) SYSTEMS AND METHODS FOR ENHANCING SUPERCAPACITOR PERFORMANCE USING TURBOSTRATIC LAYERED NON-FUNCTIONALIZED GRAPHENE IN ACTIVATED CARBON ELECTRODES

(71) Applicants: HydroGraph Clean Power Inc., Vancouver (CA); Volfpack Energy, Moratuwa (KL)

(72) Inventors: Maithri Dissanayake, Millawa (LK); Ranjith Divigalpitiya, London (CA); Charlie Karunaratne, Colombo 3 (LK)

(21) Appl. No.: 19/551,261

(22) Filed: Feb. 26, 2026

Related U.S. Application Data
(60) Provisional application No. 63/763,676, filed on Feb. 26, 2025.

(51) Int. Cl. H01G 9/042; H01G 9/00; H01G 9/035; H01G 9/048; H01G 9/145

(52) U.S. Cl. CPC H01G 9/042; H01G 9/0029; H01G 9/035; H01G 9/048; H01G 9/145

(57) ABSTRACT

An electrochemical energy storage system is disclosed that includes a first electrode disposed on a first end of the electrochemical energy storage system; a second electrode disposed on a second end of the electrochemical energy storage system opposing the first electrode; a separator disposed between the first electrode and the second electrode; and an electrolyte in ionic communication with the first electrode and the second electrode. The first electrode includes a volume of activated carbon and a volume of turbostratic layered non-functionalized graphene. The electrochemical energy storage system can be a supercapacitor.

### CROSS REFERENCE TO RELATED APPLICATION

The present application claims the benefit of and priority to U.S. Provisional Patent Application Ser. No. 63/763,676 filed Feb. 26, 2025, the entire content of which is incorporated herein in its entirety.

### TECHNICAL FIELD

The present disclosure relates to an electrochemical energy storage system, such as, for example, a supercapacitor. More specifically, an aspect of the present disclosure provides systems and methods for enhancing the performance of electrochemical energy storage systems or supercapacitors using turbostratic layered non-functionalized graphene in activated carbon electrodes. Further, an aspect of the present disclosure provides methods for identifying whether a selected electrode formulation and/or processing condition inhibits or stimulates one or more supercapacitor performance characteristics, including capacitance, resistance, energy density, power density, cycle life, and electrolyte wettability or ion transport.

### BACKGROUND

Conventional supercapacitors, including electric double layer capacitors that use activated carbon electrodes, are widely used for high power delivery, rapid charge and discharge, and long cycle life. However, many activated carbon-based electrodes exhibit performance limitations associated with electrical conductivity, ion transport within porous structures, and electrolyte access to electrochemically active surface area. In practical devices, these limitations can manifest as elevated internal resistance, reduced rate capability at higher current densities, lower usable capacitance under fast cycling, and diminished energy and power performance relative to theoretical expectations. Electrode processing and formulation variables, including binder content, particle packing, pore connectivity, and current collector contact, can further contribute to non-uniform electronic pathways and restricted electrolyte wetting, which can reduce device-to-device consistency and complicate optimization.

As a result, there remains a need for electrode architectures and material combinations that improve electronic percolation and ionic accessibility without sacrificing the desirable stability and scalability of activated carbon-based manufacturing. Accordingly, there is interest in systems and methods for enhancing supercapacitor performance using turbostratic layered non-functionalized graphene in activated carbon electrodes, including improvements in conductivity, electrolyte wettability, ion transport, capacitance retention at high rates, and reduced equivalent series resistance.

### SUMMARY

An aspect of the present disclosure provides an electrochemical energy storage system. The electrochemical energy storage system includes a first electrode disposed on a first end of the electrochemical energy storage system; a second electrode disposed on a second end of the electrochemical energy storage system opposing the first electrode; a separator disposed between the first electrode and the second electrode; and an electrolyte in ionic communication with the first electrode and the second electrode.

In another aspect of the present disclosure, the electrochemical energy storage system may be a supercapacitor.

In another aspect of the present disclosure, the first electrode may include a volume of activated carbon and a volume of turbostratic layered non-functionalized graphene.

In another aspect of the present disclosure, the volume of turbostratic layered non-functionalized graphene may include a volume of turbostratic layered non-functionalized graphene aggregate, and the volume of turbostratic layered non-functionalized graphene aggregate may be formed by an explosion or detonation process.

In another aspect of the present disclosure, the explosion or detonation process may be performed within a sealed constant-volume chamber.

In another aspect of the present disclosure, the volume of turbostratic layered non-functionalized graphene aggregate may have an elemental carbon purity of at least about 95 wt. %.

In another aspect of the present disclosure, the volume of turbostratic layered non-functionalized graphene aggregate may include sp2-bonded carbon.

In another aspect of the present disclosure, the first electrode may further include a polymer binder.

In another aspect of the present disclosure, the polymer binder may include polyvinylpyrrolidone, polyvinyl alcohol, or a combination thereof.

In another aspect of the present disclosure, the electrolyte may include a volume of tetraethylammonium tetrafluoroborate (TEABF₄) in acetonitrile (ACN).

An aspect of the present disclosure provides a method of forming an electrode for an electrochemical energy storage system. The method includes mixing a volume of activated carbon and a volume of turbostratic layered non-functionalized graphene to form a mixture; combining the mixture with a binder and a solvent to form a slurry; and depositing the slurry on a current collector to form a composite electrode layer.

In another aspect of the present disclosure, the electrochemical energy storage system may be a supercapacitor.

In another aspect of the present disclosure, the volume of turbostratic layered non-functionalized graphene may include a volume of turbostratic layered non-functionalized graphene aggregate.

In another aspect of the present disclosure, the method may further include producing the volume of turbostratic layered non-functionalized graphene aggregate by an explosion or detonation process.

In another aspect of the present disclosure, the method may further include performing the explosion or detonation process within a sealed constant-volume chamber.

In another aspect of the present disclosure, the volume of turbostratic layered non-functionalized graphene aggregate may have an elemental carbon purity of at least about 95 wt. % and may include sp2-bonded carbon.

In another aspect of the present disclosure, the binder may be a polymer binder.

In another aspect of the present disclosure, the polymer binder may include polyvinylpyrrolidone, polyvinyl alcohol, or a combination thereof.

In another aspect of the present disclosure, the method may further include forming an electrolyte that includes a volume of tetraethylammonium tetrafluoroborate (TEABF4) in acetonitrile (ACN).

An aspect of the present disclosure provides an electrochemical energy storage system. The supercapacitor system includes a first current collector; a second current collector; a first electrode disposed on the first current collector; a second electrode disposed on the second current collector, wherein at least one of the first electrode and the second electrode includes an electrode layer including a volume of activated carbon, a volume of polymer binder, and a volume of turbostratic layered non-functionalized graphene aggregate dispersed in the volume of activated carbon; a separator disposed between the first electrode and the second electrode; and an electrolyte that includes a volume of tetraethylammonium tetrafluoroborate (TEABF₄) in acetonitrile (ACN). In another aspect of the present disclosure, the volume of turbostratic layered non-functionalized graphene aggregate may be formed by explosion or detonation within a sealed constant-volume chamber. In another aspect of the present disclosure, the volume of turbostratic layered non-functionalized graphene aggregate may have an elemental carbon purity of at least about 95 wt. %. In another aspect of the present disclosure, the volume of turbostratic layered non-functionalized graphene aggregate may include sp2-bonded carbon.

Further details and aspects of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying figures of which:

FIG. 1 is an illustrative example of an electrochemical energy storage system, in accordance with aspects of the present disclosure;

FIG. 2 is an illustration of an exemplary flowchart of a method of forming an electrode for the electrochemical energy storage system of FIG. 1, in accordance with aspects of the present disclosure;

FIG. 3 is an illustration of an exemplary flowchart of a method of forming an electrode for the electrochemical energy storage system of FIG. 1, in accordance with aspects of the present disclosure;

FIG. 4 is an illustration of an exemplary flowchart of the method of FIG. 2, in accordance with aspects of the present disclosure;

FIG. 5 is a diagram of ultraviolet-visible absorption spectra of the system of FIG. 1, in accordance with aspects of the present disclosure;

FIG. 6 is a diagram of X-ray diffraction patterns of the system of FIG. 1, in accordance with aspects of the present disclosure;

FIG. 7 is a diagram of Raman spectra of the system of FIG. 1, in accordance with aspects of the present disclosure; and

FIG. 8 is a block diagram of a controller configured for use with the system of FIG. 1, in accordance with aspects of the present disclosure.

### DETAILED DESCRIPTION

The present disclosure relates to an electrochemical energy storage system, including aspects directed to carbon-based electrodes and methods of forming composite electrode layers for use in supercapacitor applications. Aspects of the present disclosure are described in detail with reference to the figures, in which like reference numerals identify similar or identical elements.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the figures, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

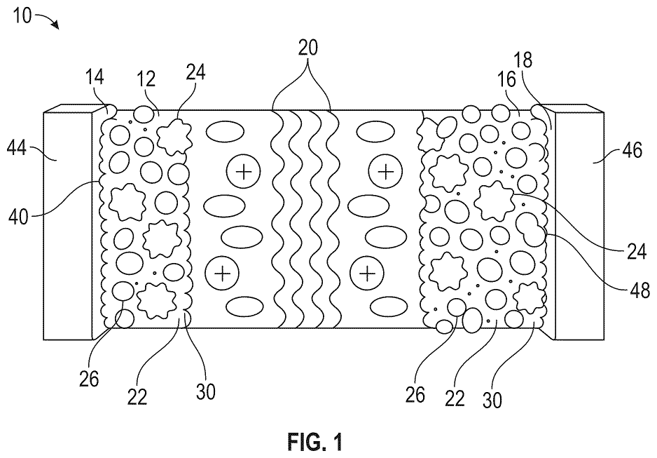

Referring to FIGS. 1-3, an electrochemical energy storage system 10 is shown, in accordance with aspects of the present disclosure. The electrochemical energy storage system 10 may be implemented as a supercapacitor system designed for rapid charge and discharge, high cycle life, and high-power density, with energy storage based on ionic charge separation at electrolyte-accessible surfaces of carbon-based electrodes rather than bulk chemical transformation. In various aspects, the electrochemical energy storage system 10 is configured to deliver high peak currents over short time intervals, accept fast recharge without significant degradation, and operate with low internal resistance to reduce heat generation during pulsed operation. The electrochemical energy storage system 10 may be selected for duty cycles that include frequent shallow cycling, repeated high-rate cycling, and intermittent regenerative energy capture, including operating regimes where power demand changes on a sub-second timescale. In some aspects, the electrochemical energy storage system 10 is configured to operate across a defined voltage window suitable for the selected chemistry, and to provide a predictable linear voltage response during discharge as is characteristic of capacitive storage. The electrochemical energy storage system 10 may be sized as a single cell, a multi-cell series string, or a parallel assembly to meet target voltage and capacitance specifications, and in some aspects the electrochemical energy storage system 10 is integrated into a module that includes balancing circuitry, sensing leads, and protective elements that manage voltage equalization and operational limits.

The electrochemical energy storage system 10 has a first end 14 and a second end 18, with a first electrode 12 positioned at the first end 14 and a second electrode 16 positioned at the second end 18 so that the first electrode 12 and the second electrode 16 oppose one another across an intervening separator 20. The first end 14 and the second end 18 may correspond to opposing regions of an enclosure that defines the overall geometry, including end regions of a cylindrical can, end regions of a prismatic can, opposing faces of a laminated pouch enclosure, or opposing axial ends of a wound electrode assembly. In some aspects, the first end 14 and the second end 18 are associated with external terminal locations, with electrical isolation features positioned to prevent shorting and to maintain mechanical robustness under shock and vibration. The first end 14 and the second end 18 may also define the direction of assembly of a first electrode 12 and second electrode 16 stack, the placement of compression features, and routing of current paths to reduce resistive losses. In various aspects, the electrochemical energy storage system 10 includes internal compressive support structures that apply uniform pressure across the first electrode 12, second electrode 16, and separator 20 stack to maintain interfacial contact, reduce contact resistance, and preserve separator 20 integrity, including elastomeric pads, spring elements, folded spacers, rigid end plates, or crimped closures that generate stack pressure. The electrochemical energy storage system 10 may also include internal features that promote electrolyte distribution and wetting, including flow channels, edge gaps, textured surfaces, or porous wicking layers that reduce dry spots and improve ionic access throughout first electrode 12 and second electrode 16 thickness.

An electrolyte 22 is disposed within the electrochemical energy storage system 10 and is in ionic communication with both the first electrode 12 and the second electrode 16. In various aspects, the electrolyte 22 fills pores within the first electrode 12 and the second electrode 16, saturates the separator 20, and provides ionic conduction pathways between the first electrode 12 and the second electrode 16. The electrochemical energy storage system 10 may be assembled using vacuum filling, pressure filling, soak filling, or metered dispensing of the electrolyte 22, followed by a wetting period selected to achieve uniform infiltration. In some aspects, the electrochemical energy storage system 10 is hermetically sealed to retain the electrolyte 22 and inhibit moisture ingress, and the sealing approach is selected based on package type and operating environment. The electrochemical energy storage system 10 may incorporate seal materials such as heat seals, polymer edge seals, gaskets, crimp seals, glass-to-metal seals, or laser-welded closures, depending on whether the electrochemical energy storage system 10 is a pouch format, a prismatic format, a coin format, or a cylindrical format. In some aspects, the electrochemical energy storage system 10 includes venting or pressure management features to accommodate internal pressure changes during manufacturing, formation cycling, or extreme operating events, including burst disks, vent grooves, or controlled-leak vents configured to release pressure in a directed manner.

In various aspects, the electrochemical energy storage system 10 is packaged as a stacked cell, a wound jelly-roll cell, a prismatic cell, a coin or button cell, or a pouch cell, with terminals or tabs coupled to at least one of a first current collector 44 and a second current collector 46 and configured to couple to external circuitry. In stacked cell aspects, multiple layers of the first electrode 12, the separator 20, and the second electrode 16 are arranged in a repeated sequence to increase capacitance, and the stack may be compressed and housed in a rigid enclosure or a laminated pouch. In wound jelly-roll aspects, the first electrode 12, the separator 20, and the second electrode 16 are formed as elongated sheets and wound into a spiral roll to achieve high electrode area in a compact volume, with a center core or mandrel optionally used to control winding geometry and prevent buckling. In prismatic aspects, the electrochemical energy storage system 10 may include a stacked or wound assembly placed into a rectangular prismatic can to improve volumetric packing efficiency for module integration. In coin or button aspects, the electrochemical energy storage system 10 may be formed as a compact disc-shaped assembly with crimped metal housings that support robust sealing and consistent contact pressure.

In pouch aspects, the electrochemical energy storage system 10 may be sealed within an aluminum-laminate pouch to reduce mass and allow flexible packaging, with tab leads extending through the seal region and supported by strain relief features. Terminals or tabs may be arranged in a same-side configuration, an opposite-side configuration, or an offset configuration depending on module layout, and in some aspects the electrochemical energy storage system 10 includes busbars, welded joints, riveted joints, or conductive adhesives to connect the terminals or tabs to external conductors. In various aspects, the electrochemical energy storage system 10 is designed to withstand thermal cycling and mechanical vibration, including design features that accommodate differential expansion among enclosure materials, current collectors, and electrode layers.

The electrochemical energy storage system 10 may be used in applications that benefit from high pulse power and fast transient response, such as regenerative braking, engine start assist, power smoothing for renewable generation, peak shaving, uninterruptible power support, industrial pulse loads, power tools, consumer electronics buffering, and hybrid energy storage modules paired with batteries to reduce battery peak current demand. In regenerative braking aspects, the electrochemical energy storage system 10 may accept rapid bursts of recovered energy and deliver that energy during subsequent acceleration, reducing stress on batteries and improving overall efficiency. In engine start assist aspects, the electrochemical energy storage system 10 may provide high current pulses for starter motors while maintaining stable voltage under heavy load. In renewable generation smoothing and peak shaving aspects, the electrochemical energy storage system 10 may buffer short-duration fluctuations in power output or load demand, supporting grid stability and reducing demand charges. In uninterruptible power support aspects, the electrochemical energy storage system 10 may provide immediate bridging power during switchover events or short outages, and may be combined with batteries, generators, or fuel cells. In industrial pulse load aspects, the electrochemical energy storage system 10 may support welding, actuator bursts, solenoid banks, pulsed lasers, and other equipment where momentary high-power draw is required. In power tool and consumer electronics aspects, the electrochemical energy storage system 10 may reduce peak current demand on primary batteries, support quick charge features, and stabilize voltage during rapid load changes. In hybrid module aspects, the electrochemical energy storage system 10 may be integrated with batteries in a common housing with control electronics that allocate high-frequency power demand to the electrochemical energy storage system 10 and allocate longer-duration energy demand to the batteries, thereby extending battery life and improving system performance.

The first end 14 and the second end 18 represent opposing regions of the electrochemical energy storage system 10 that support the internal first electrode 12 and second electrode 16 stack and provide a frame of reference for assembly, orientation, and current flow through the electrochemical energy storage system 10. The first end 14 and the second end 18 may be defined by structural boundaries of a housing (not shown), including opposing end walls of a prismatic enclosure, opposing end caps of a cylindrical enclosure, or opposing sealed perimeter regions of a pouch enclosure. In certain aspects, the first end 14 and the second end 18 are established by a closure region and an opposing base region of a rigid can, where the closure region captures an insulating gasket and a terminal feedthrough and the base region serves as a reference surface for the active assembly. In other aspects, the first end 14 and the second end 18 correspond to outermost faces of a stacked laminate in which alternating layers of a first electrode 12, a separator 20, and a second electrode 16 are arranged in a repeated sequence, and the outermost faces of that laminate interface with compression plates, insulating sheets, or structural spacers. In further aspects, the first end 14 and the second end 18 correspond to axial ends of a wound electrode assembly formed as a jellyroll, with current collector tab routing, insulating wraps, and electrolyte access pathways organized with reference to the axial ends to achieve repeatable assembly and consistent electrical performance.

The first end 14 and the second end 18 may be configured to maintain mechanical integrity of the electrochemical energy storage system 10 under operational loads that include vibration, shock, thermal cycling, and long-term relaxation of compressive elements. A housing defining the first end 14 and the second end 18 may include internal features that constrain the first electrode 12 and second electrode 16 stack against lateral shifting, such as ribs, ledges, shoulders, locating bosses, or insulating frames that engage edges of the first electrode 12 and second electrode 16 stack. Electrical isolation components may be positioned near one or both of the first end 14 and the second end 18 to maintain separation between conductive elements and the housing, including polymer gaskets, ceramic or glass feedthroughs, insulating spacers, laminated insulator sheets, or molded insulating collars around terminal structures. Sealing structures located at the first end 14, at the second end 18, or along a perimeter between the first end 14 and the second end 18 may retain the electrolyte 22 and inhibit moisture ingress, including heat-sealed pouch edges, crimped seams, welded seams, adhesive seals, or gasketed seals, with seal materials selected for chemical compatibility with organic electrolytes and long-term dimensional stability.

When the electrochemical energy storage system 10 is packaged in a prismatic enclosure, the first end 14 and the second end 18 may correspond to opposing ends of a rectangular can, where one end region supports one or more external terminals and the opposing end region supports the stacked or wound active assembly. When the electrochemical energy storage system 10 is packaged in a pouch enclosure, the first end 14 and the second end 18 may correspond to opposing edge regions or opposing faces of an aluminum-laminate film package, including regions near tab exits where reinforcement layers, strain relief structures, or thicker seal bands may be positioned. When the electrochemical energy storage system 10 is packaged in a cylindrical enclosure, the first end 14 may correspond to an end cap region and the second end 18 may correspond to a closed base region of a drawn can, or vice versa, depending on terminal design and assembly orientation. The housing may also include an external polymer or composite shell that provides electrical insulation and impact protection while internal metallic current pathways route to external terminals located near one or both ends.

When the electrochemical energy storage system 10 uses a wound first electrode 12 and second electrode 16 assembly, the first end 14 and the second end 18 may correspond to opposite axial ends of the jellyroll, which serve as reference planes for aligning current collector tabs, insulating wraps, and optional support structures. A central mandrel, pin, or hollow core may be positioned along the winding axis, and tab placement and insulating wrap extent may be controlled relative to the first end 14 and the second end 18 to manage electrical clearances and reduce edge-short risk. Insulating wraps may extend around the outer circumference of the wound assembly and may extend toward one or both axial ends to increase creepage distance, control edge alignment, and reduce the likelihood of exposed first electrode 12 and second electrode 16 edges contacting opposing conductive components.

The electrochemical energy storage system 10 may include mechanical features that compress the first electrode 12 and second electrode 16 stack to reduce contact resistance and maintain separator 20 wetting, with the compressive architecture selected to provide uniform pressure distribution across the active area. Compression may be provided by springs that apply axial force between structures adjacent the first end 14 and the second end 18, including wave springs, coil springs, Belleville washers, or spring plates that maintain force over thermal cycling and material relaxation. Compliant pads may be positioned adjacent the first electrode 12 and second electrode 16 stack, including elastomeric pads, foam pads, silicone pads, or compressible polymer sheets that accommodate dimensional tolerances while maintaining a target compressive load. Stacked assemblies may be clamped within compression frames or between end plates using tie rods, bolts, rivets, or welded joints that maintain a predetermined compression load. In rigid can formats, crimped closures may contribute to compression by capturing a gasket and driving an end cap into a controlled position relative to internal components, with crimp geometry selected to maintain seal integrity while applying a desired mechanical load. In pouch formats, laminated edge seals and optional external frames may help maintain planar compression and limit swelling, thereby supporting consistent ionic access and reducing localized dry regions. Compression may be tuned to preserve separator 20 integrity, inhibit extrusion of electrode material, and prevent wrinkling or buckling, while still improving particle-to-collector contact and promoting uniform electrolyte 22 distribution within pores.

Electrical terminals may be positioned near one or both of the first end 14 and the second end 18 to reduce internal path length and resistive losses, and terminal placement may be selected to suit series stacking, parallel stacking, or module-level busbar arrangements. Terminals may be positioned on the same side of the electrochemical energy storage system 10 to simplify module assembly and busbar routing, or terminals may be positioned on opposing sides to distribute current collection and reduce current crowding across the electrode area. Terminal structures may include welded tabs, riveted studs, threaded posts, blade terminals, or flat busbar interfaces, and insulating collars, gaskets, or feedthrough components may isolate the terminals from the housing. Tab geometry, tab width, and tab thickness may be selected to support high current pulses with minimal temperature rise, and multiple tabs may be used per electrode to reduce current density and lower equivalent series resistance. The electrochemical energy storage system 10 may also include provisions for monitoring and integration within a higher-level control architecture, including voltage sense leads, temperature sensor placement near one or both ends, and optional pressure or strain indicators positioned in an end region to monitor operating state and long-term health.

The first electrode 12 and the second electrode 16 may each be configured as porous, electronically conductive electrode layers positioned to cooperate with the separator 20 to provide a desired capacitance, impedance, and power response for the electrochemical energy storage system 10. In this arrangement, the first electrode 12 includes a porous, electronically conductive first electrode layer 40 supported by the first current collector 44, and the second electrode 16 includes a porous, electronically conductive second electrode layer 48 supported by the second current collector 46. The first electrode layer 40 and the second electrode layer 48 may each be formed as a planar sheet, a patterned sheet, a segmented sheet, or a shaped sheet depending on the package format of the electrochemical energy storage system 10, including circular geometries for coin and button formats, rectangular or square geometries for stacked pouch and prismatic formats, and elongated strip geometries for wound jelly-roll formats. The first electrode layer 40 and the second electrode layer 48 may each have a substantially uniform thickness across an active area or may have intentionally varied thickness, edge tapering, densified regions, or patterned porosity selected to manage current distribution, reduce edge effects, improve electrolyte 22 infiltration, or reduce localized heating at high current. In supercapacitor implementations, the first electrode layer 40 and the second electrode layer 48 may each be predominantly carbon-based to provide high accessible surface area, controlled pore size distribution, strong adhesion to the first current collector 44 and the second current collector 46, respectively, and stable ionic access throughout the thickness of the first electrode layer 40 and the second electrode layer 48, with the pore structure selected so ions from the electrolyte 22 access internal surface area without excessive diffusion limitation during high-rate operation.

Thickness of the first electrode layer 40 and the second electrode layer 48 may be selected to balance energy and power. Thinner layers generally provide shorter ionic path length and lower equivalent series resistance, which may improve high-rate performance and reduce heat generation, while thicker layers generally provide higher areal capacitance and higher total stored energy per unit footprint when ionic transport remains adequate. In aspects, the first electrode layer 40 and the second electrode layer 48 may each be formed as films ranging from tens of micrometers to several hundreds of micrometers, and in configurations oriented toward higher areal loading the thickness may extend toward about a millimeter when electrolyte 22 infiltration and ionic transport remain acceptable. Thickness targets may be coordinated with separator 20 thickness, electrolyte 22 viscosity and conductivity, and an intended discharge pulse width so that the electrochemical energy storage system 10 maintains a desired voltage response under a highest expected current. The first electrode layer 40 and the second electrode layer 48 may each be engineered as single-layer coatings on the first current collector 44 and the second current collector 46, respectively, or as multilayer structures in which a first sublayer promotes adhesion to the corresponding current collector and one or more additional sublayers provide higher porosity or higher active loading, with interfaces between sublayers designed to avoid delamination during cycling.

Areal mass loading of the first electrode layer 40 and the second electrode layer 48 may be selected based on the first current collector 44 and the second current collector 46, the device format of the electrochemical energy storage system 10, and a targeted impedance, and may range from a few milligrams per square centimeter to several tens of milligrams per square centimeter. The first electrode layer 40 and the second electrode layer 48 may be calendared, pressed, or otherwise densified to adjust density and porosity. Calendaring may be used to reduce thickness variation, increase particle-to-particle contact, reduce contact resistance to the first current collector 44 and the second current collector 46, and tune pore volume so electrolyte 22 infiltration and wetting are maintained while electronic conductivity pathways remain continuous. Porosity may be tuned to include macro-pores that act as electrolyte reservoirs and transport highways, meso-pores that reduce diffusion distance into the structure, and micro-pores that provide high surface area for charge storage. The first electrode layer 40 and the second electrode layer 48 may also be designed with controlled tortuosity, with pore networks that allow the electrolyte 22 to penetrate through full thickness during filling and to maintain ionic access during repeated cycling.

The first electrode layer 40 and the second electrode layer 48 may each be formed as free-standing films that are later laminated or pressed onto the first current collector 44 and the second current collector 46, respectively, or may be deposited directly onto the first current collector 44 and the second current collector 46 by coating, spraying, printing, or other deposition approaches. A free-standing film approach may be useful when tight control over film thickness and density is desired prior to lamination, or when double-sided coating is performed by laminating films onto both sides of a current collector. Direct deposition approaches may include doctor blading, slot-die coating, roll coating, spray coating, screen printing, stencil printing, gravure coating, or related processes selected for laboratory-scale fabrication or roll-to-roll manufacturing. The first current collector 44 and the second current collector 46 may each be provided as foils, meshes, expanded metals, perforated sheets, patterned sheets, or composite structures, with surfaces optionally roughened, textured, etched, or coated to increase adhesion with the first electrode layer 40 and the second electrode layer 48. The first current collector 44 and the second current collector 46 may be selected from aluminum-based materials, stainless steel materials, nickel-based materials, titanium-based materials, or conductive carbon-based collectors, with thickness selected to provide mechanical support, low resistive loss, and compatibility with joining operations for external terminals or tabs. The first current collector 44 and the second current collector 46 may each include a tab or terminal extension region free of electrode coating to facilitate welding, riveting, crimping, or other joining to external circuitry.

The first electrode 12 and the second electrode 16 may each include a volume of activated carbon 24 within the first electrode layer 40 and the second electrode layer 48. The volume of activated carbon 24 may be provided as a powder with high internal surface area and a network of micro-, meso-, and macro-pores that store charge through formation of an electric double layer at a carbon-electrolyte interface. Selection of the volume of activated carbon 24 may be based on specific surface area, pore size distribution, pore accessibility in the presence of the electrolyte 22, ash content, moisture content, particle mechanical strength, and compatibility with the electrolyte 22 and an operating voltage window of the electrochemical energy storage system 10. The volume of activated carbon 24 may be derived from coconut shell, wood, coal, petroleum pitch, or polymer precursors, and may be chemically activated or physically activated to produce a targeted pore structure. Particle size distribution of the volume of activated carbon 24 may be selected to support uniform mixing and coating and to provide stable, crack-resistant first electrode 12 and second electrode 16 layers, with median particle sizes in a range of a few micrometers to several tens of micrometers and with a controlled fraction of smaller particles to fill interstitial voids for improved packing and contact. The volume of activated carbon 24 may serve as a matrix that receives and distributes additional conductive additives and structural additives, and the microstructure may be engineered so the volume of activated carbon 24 particles form a continuous porous skeleton that supports rapid ion movement from the electrolyte 22 into interiors of the first electrode layer 40 and the second electrode layer 48.

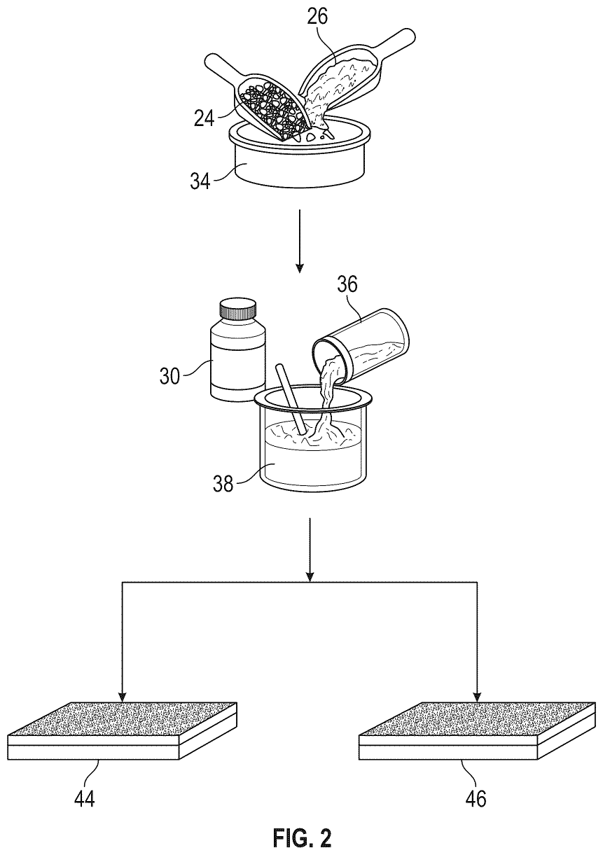

The first electrode 12 and the second electrode 16 may each further include a volume of turbostratic layered non-functionalized graphene 26 within the first electrode layer 40 and the second electrode layer 48. The volume of turbostratic layered non-functionalized graphene 26 may be present at a relatively low fraction compared to the volume of activated carbon 24, selected to improve electrical conductivity pathways, improve wetting behavior with the electrolyte 22, and influence ionic diffusion within a composite microstructure by shaping conductive networks and modifying packing morphology. The volume of turbostratic layered non-functionalized graphene 26 may be present as a powder additive that disperses throughout the volume of activated carbon 24, reducing internal resistance by bridging activated carbon particles and forming conductive percolation networks that reduce electron transport limitations during high current pulses, and may also reduce a number of high-resistance particle-to-particle interfaces within the electrode layers, thereby lowering equivalent series resistance and improving power capability for the electrochemical energy storage system 10. The volume of turbostratic layered non-functionalized graphene 26 may be described as layered graphene-based material having turbostratic stacking where adjacent layers exhibit rotational misalignment rather than strict Bernal stacking, which may influence interlayer spacing and a tendency of the material to restack and may support improved accessibility of electrolyte 22 compared to more tightly stacked graphitic structures when incorporated into the first electrode layer 40 and the second electrode layer 48. The volume of turbostratic layered non-functionalized graphene 26 is non-functionalized in the sense that deliberate oxygen-, nitrogen-, or other heteroatom functional groups are not introduced as part of the material design, which may support stability in organic electrolytes and reduce undesired side reactions that can contribute to gas generation or impedance rise, and carbon bonding of the volume of turbostratic layered non-functionalized graphene 26 may be predominantly sp2-bonded carbon, supporting high electrical conductivity and mechanical resilience under compression. Within the first electrode layer 40 and the second electrode layer 48, relative amounts of the volume of activated carbon 24 and the volume of turbostratic layered non-functionalized graphene 26 may be selected based on target conductivity, target capacitance retention at high rate, and manufacturability of a slurry 38 (FIG. 2) that coats uniformly on the first current collector 44 and the second current collector 46, with mixing conditions selected so the volume of turbostratic layered non-functionalized graphene 26 distributes throughout the volume of activated carbon 24 without forming isolated clumps that create non-uniform coating thickness or local densification, and with conductive networks formed by the volume of turbostratic layered non-functionalized graphene 26 remaining continuous to interfaces with the first current collector 44 and the second current collector 46 to promote efficient current collection during charging and discharging.

In some aspects, the first electrode 12 and the second electrode 16 are each implemented as a plurality of electrodes arranged as an electrode stack rather than as a single opposing pair. In these aspects, the electrochemical energy storage system 10 includes repeated sequences of electrode layers separated by one or more separators 20 so that ionic transport occurs across each separator 20 while electronic isolation is maintained between adjacent electrodes. For example, the first electrode 12 may represent a first polarity electrode set that includes multiple first electrode layers 40 distributed through the stack, and the second electrode 16 may represent a second polarity electrode set that includes multiple second electrode layers 48 distributed through the stack, with the separator 20 disposed between each adjacent first electrode layer 40 and second electrode layer 48. This architecture increases total capacitance by increasing total active interfacial area while preserving a cell-level terminal structure at the first end 14 and the second end 18. In some aspects, the plurality of electrodes is implemented as a stacked laminate, a folded stack, or a wound jellyroll where layers repeat circumferentially. The separator 20 may be sized to extend beyond lateral edges of the plurality of electrodes to reduce edge-short risk, and compression features described above may apply uniform stack pressure across the plurality of electrodes to maintain contact and preserve separator 20 integrity during vibration, thermal cycling, and high-rate pulsing.

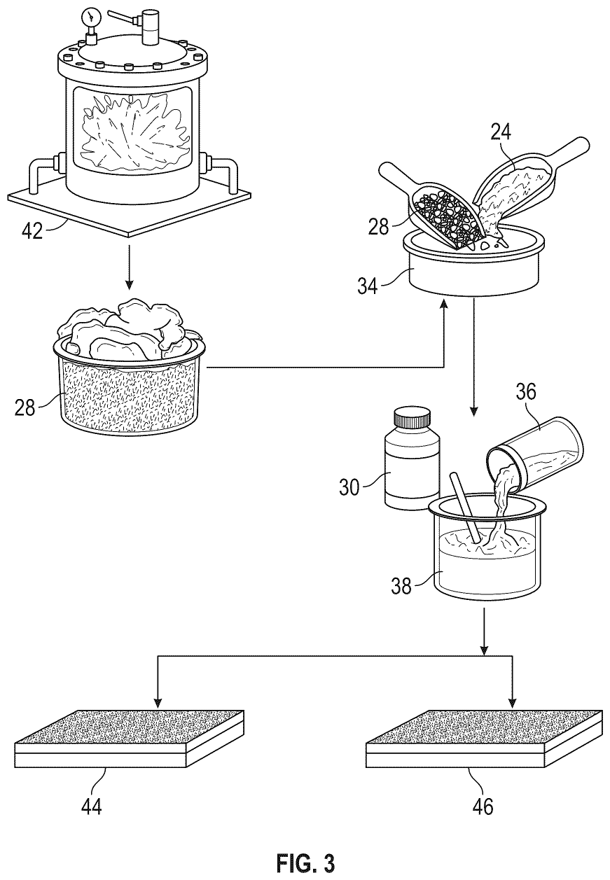

As shown in FIG. 3, in aspects, the volume of turbostratic layered non-functionalized graphene 26 may include a volume of turbostratic layered non-functionalized graphene aggregate 28 dispersed within the volume of activated carbon 24 so that the first electrode layer 40 and the second electrode layer 48 each include a hybrid carbon architecture that combines a high-surface-area volume of activated carbon 24 with a conductive graphene-based network. The volume of turbostratic layered non-functionalized graphene aggregate 28 may be present as a powder of aggregated nano-platelets in which primary platelets have nanoscale lateral dimensions and are arranged as few-layer stacks, and those few-layer stacks associate into larger secondary structures that behave as free-flowing or fluffy powders. This hierarchical morphology allows the volume of turbostratic layered non-functionalized graphene aggregate 28 to distribute throughout the volume of activated carbon 24 and interact with a binder 30 without requiring chemical functionalization, while still forming conductive pathways that bridge activated carbon particles and reduce internal resistance. The volume of turbostratic layered non-functionalized graphene aggregate 28 may include irregular clusters, loose agglomerates, partially interconnected chains, or plate-like flocs depending on synthesis conditions and downstream powder handling, and these forms may be selected to balance dispersion, conductivity, and processability during formation of the slurry 38 and subsequent deposition as the first electrode layer 40 and the second electrode layer 48.

Primary few-layer structures within the volume of turbostratic layered non-functionalized graphene aggregate 28 may have an average layer count on the order of several graphene layers, with a distribution that may extend from a few layers to less than or equal to ten layers, and with an effective thickness on the order of a few nanometers. Lateral dimensions of the primary platelets within the volume of turbostratic layered non-functionalized graphene aggregate 28 may be in the order of tens of nanometers, while secondary structures that define the volume of turbostratic layered non-functionalized graphene aggregate 28 may present an effective radius of gyration on the order of hundreds of nanometers. In practical handling and electrode fabrication, this multi-scale structure provides a balance between high surface area and manageable powder behavior, because the volume of turbostratic layered non-functionalized graphene aggregate 28 may resist complete restacking into dense graphite-like particles while still remaining sufficiently aggregated to be handled, weighed, and mixed without specialized dispersion aids. The volume of turbostratic layered non-functionalized graphene aggregate 28 may behave as a low-density powder that occupies a relatively large apparent volume for a given mass, which can promote formation of conductive networks at relatively low loading within the first electrode layer 40 and the second electrode layer 48, and can also influence packing of the volume of activated carbon 24 by introducing conductive bridges and micro-scale spacing that supports electrolyte 22 access.

The volume of turbostratic layered non-functionalized graphene aggregate 28 may exhibit high sp2-bonded carbon character and high elemental carbon content. The volume of turbostratic layered non-functionalized graphene aggregate 28 may have an elemental carbon purity at or above about 95 weight percent, and in further configurations the elemental carbon purity of the volume of turbostratic layered non-functionalized graphene aggregate 28 is higher with low oxygen content and low total impurities. High elemental carbon purity of the volume of turbostratic layered non-functionalized graphene aggregate 28 may reduce inorganic contaminants that increase leakage current or catalyze undesirable side reactions and may also support consistent electrical conductivity and predictable electrochemical behavior across manufacturing lots. Predominantly sp2-bonded carbon within the volume of turbostratic layered non-functionalized graphene aggregate 28 supports high electronic conductivity, allowing the volume of turbostratic layered non-functionalized graphene aggregate 28 to function as a conductive additive that reduces resistive losses within the first electrode layer 40 and the second electrode layer 48, particularly under high pulse currents. The turbostratic nature of the layered structure of the volume of turbostratic layered non-functionalized graphene aggregate 28 may also reduce the tendency of graphene layers to pack into tightly ordered graphitic stacks, helping maintain accessible surface area and supporting interaction with the electrolyte 22 when incorporated into porous activated carbon matrices.

The volume of turbostratic layered non-functionalized graphene aggregate 28 may be hydrophobic and may have no intentionally added dispersants or surfactants. Dispersion and distribution of the volume of turbostratic layered non-functionalized graphene aggregate 28 within the volume of activated carbon 24 may be achieved primarily through mechanical mixing conditions used to form a mixture 34 and through selection of the binder 30 and solvent 36 used to form the slurry 38, as depicted in FIG. 2. The binder 30 may be selected to promote adhesion between the volume of turbostratic layered non-functionalized graphene aggregate 28 and the volume of activated carbon 24, stabilize distribution of the volume of turbostratic layered non-functionalized graphene aggregate 28 during coating, and preserve a conductive network formed by the volume of turbostratic layered non-functionalized graphene aggregate 28 after drying. Mechanical mixing may be carried out with sufficient shear and mixing time to break down large clumps of the volume of turbostratic layered non-functionalized graphene aggregate 28 while retaining the hierarchical structure that supports conductive connectivity. The specific surface area of the volume of turbostratic layered non-functionalized graphene aggregate 28 may be on the order of hundreds of square meters per gram, supporting electrochemical accessibility when the volume of turbostratic layered non-functionalized graphene aggregate 28 is integrated within the volume of activated carbon 24, and this accessible surface area may contribute to charge storage and interfacial ion adsorption while also providing additional conductive pathways.

The volume of turbostratic layered non-functionalized graphene aggregate 28 may be formed by an explosion or detonation process, and the explosion or detonation process may be performed within a sealed constant-volume chamber 42. The sealed constant-volume chamber 42 may be configured as a pressure-rated vessel designed to contain a carbon-bearing feedstock and sustain a rapid energetic event that produces high-temperature, high-pressure conditions for a short duration, followed by quenching that yields powdered carbon material having turbostratic few-layer structure corresponding to the volume of turbostratic layered non-functionalized graphene aggregate 28. The sealed constant-volume chamber 42 may be fabricated from stainless steel, nickel-based alloys, or other high-strength metals suitable for repeated pressure cycling, and the sealed constant-volume chamber 42 may include structural reinforcement features such as thick walls, external hoops, or internal liners to manage peak pressure loads. The sealed constant-volume chamber 42 may include igniters, initiation hardware, gas feed valves, exhaust valves, pressure sensors, temperature sensors, and safety interlocks configured to control a pressure-time profile and provide repeatable production conditions for the volume of turbostratic layered non-functionalized graphene aggregate 28. The sealed constant-volume chamber 42 may further include powder recovery subsystems such as filters, cyclone separators, collection canisters, or inert-atmosphere transfer containers to capture the volume of turbostratic layered non-functionalized graphene aggregate 28 while limiting contamination and moisture uptake.

The first electrode 12 and the second electrode 16 may each include the binder 30 within the first electrode layer 40 and within the second electrode layer 48 to provide mechanical integrity, adhesion to the first current collector 44 and the second current collector 46, cohesion among the volume of activated carbon 24 and the volume of turbostratic layered non-functionalized graphene 26, and durability under repeated wetting by the electrolyte 22 and repeated electrochemical cycling. The binder 30 may act as a continuous or semi-continuous phase that ties together particles and aggregates, resists cracking or flaking during drying and calendaring, and maintains intimate contact between the first electrode layer 40 and the first current collector 44 and between the second electrode layer 48 and the second current collector 46 so that current collection remains stable over life. The binder 30 may also support robustness during manufacturing steps such as cutting, winding, stacking, tab welding, and assembly compression, where shear and bending forces can otherwise create edge shedding or delamination from the first current collector 44 or the second current collector 46. The binder 30 may be selected to maintain cohesion in the presence of the electrolyte 22, including maintaining adhesion at particle interfaces within the first electrode layer 40 and the second electrode layer 48 and at interfaces with the first current collector 44 and the second current collector 46 during prolonged exposure to organic solvents and dissolved salt species.

The binder 30 may be a polymer binder selected for film-forming behavior, adhesion, chemical compatibility, and mechanical resilience. Suitable polymer binders for the binder 30 include polyvinylpyrrolidone, polyvinyl alcohol, or combinations thereof. Polyvinylpyrrolidone used as the binder 30 may support dispersion stabilization and adhesion in solvent systems used to form the slurry 38, including promoting uniform distribution of the volume of turbostratic layered non-functionalized graphene 26 and inhibiting formation of localized clumps during coating of the first electrode layer 40 or the second electrode layer 48. Polyvinyl alcohol used as the binder 30 may contribute strong film-forming behavior and mechanical robustness after drying, including resistance to cracking when the first electrode layer 40 or the second electrode layer 48 is calendared or when the electrochemical energy storage system 10 is assembled under compression. Combinations of polyvinylpyrrolidone and polyvinyl alcohol used as the binder 30 may be selected to tune rheology of the slurry 38, drying behavior, and electrode flexibility, with blend ratio selected to balance coating uniformity with final cohesion of the first electrode layer 40 and the second electrode layer 48.

The binder 30 may be selected to be compatible with a volume of tetraethylammonium tetrafluoroborate (TEABF4) in acetonitrile (ACN) and to maintain mechanical stability without significant dissolution, softening, or loss during operation. Compatibility of the binder 30 may include resistance to extraction of polymer chains into the electrolyte 22, resistance to swelling that would disrupt pore structure within the first electrode layer 40 or the second electrode layer 48, and retention of adhesion at the interface between the first electrode layer 40 and the first current collector 44 and at the interface between the second electrode layer 48 and the second current collector 46 during extended cycling and temperature variation. The binder 30 may also be selected so that the binder 30 does not introduce excessive ionic resistance by blocking pores or forming insulating films at critical conduction pathways within the first electrode layer 40 or the second electrode layer 48. The binder 30 may tolerate drying conditions used to remove the solvent 36 from the slurry 38 and may tolerate moderate thermal processing used to stabilize the first electrode layer 40 and the second electrode layer 48, while remaining stable in air during storage and stable under inert atmosphere if higher temperature drying is employed.

A fraction of the binder 30 may be selected to balance conductivity and integrity, with the binder 30 typically present as a minor fraction of total dried electrode solids so that the volume of activated carbon 24 remains the dominant surface-area-providing component and the volume of turbostratic layered non-functionalized graphene 26 remains effective as a conductive additive. For example, the binder 30 may be present at a few weight percent of total dried solids, with the fraction selected based on surface area of the powders, particle size distribution, electrode flexibility targets, and the coating method used to deposit the slurry 38. Lower fractions of the binder 30 may be used when conductivity and pore accessibility are prioritized and the first electrode layer 40 and the second electrode layer 48 can still be handled without flaking. Higher fractions of the binder 30 may be used when improved adhesion, reduced dusting, or improved mechanical durability is desired for winding and handling, provided pore blockage and resistive effects remain acceptable. The binder 30 may be distributed uniformly throughout the first electrode layer 40 and throughout the second electrode layer 48, or concentration of the binder 30 may be graded, such as higher concentration near the first current collector 44 interface and near the second current collector 46 interface to improve adhesion and lower concentration toward electrolyte-facing regions to preserve pore accessibility and active surface area.

A solids ratio among the volume of turbostratic layered non-functionalized graphene 26, the volume of activated carbon 24, and the binder 30 may be selected to provide improved specific capacitance relative to activated carbon-based electrodes and improved power performance by reducing internal resistance. The volume of turbostratic layered non-functionalized graphene 26 may be used as a small additive relative to the volume of activated carbon 24 to form conductive bridges and percolation pathways while minimizing displacement of activated carbon surface area, and the binder 30 may remain a minor fraction used primarily for adhesion and cohesion. The overall formulation may be adjusted so that the first electrode layer 40 and the second electrode layer 48 maintain sufficient porosity for electrolyte 22 infiltration and ion transport. Ratio selection may also account for how the binder 30 interacts with surfaces of the volume of activated carbon 24 and surfaces of the volume of turbostratic layered non-functionalized graphene 26, including selecting conditions that preserve conductive contacts and avoid excessive coating of conductive surfaces by insulating polymer. In this manner, the binder 30 supports manufacturability and durability of the first electrode 12 and the second electrode 16 while preserving electrochemical performance benefits associated with combining the volume of activated carbon 24 with the volume of turbostratic layered non-functionalized graphene 26 within the first electrode layer 40 and within the second electrode layer 48.

In some aspects, the solids formulation of each of the first electrode layer 40 and the second electrode layer 48 is characterized by a defined ratio among the volume of turbostratic layered non-functionalized graphene 26, the volume of activated carbon 24, and the binder 30. The ratio may be expressed as a mass-based ratio, a parts-by-weight ratio, a weight percent formulation, or a volume-based ratio depending on how raw materials are metered during manufacturing and how the formulation is reported for quality control. In certain aspects, a representative formulation uses a ratio of 1:25:1 for turbostratic layered non-functionalized graphene 26 relative to activated carbon 24 and binder 30, respectively, where the turbostratic layered non-functionalized graphene 26 functions as a conductive additive present at a smaller fraction than the volume of activated carbon 24, and the binder 30 remains a minor fraction selected for cohesion and adhesion. In these aspects, the ratio is selected so that the volume of activated carbon 24 remains the dominant contributor to accessible surface area for electric double-layer formation while the volume of turbostratic layered non-functionalized graphene 26 improves conductive connectivity and reduces resistive loss within the electrode microstructure. When the volume of turbostratic layered non-functionalized graphene 26 includes the volume of turbostratic layered non-functionalized graphene aggregate 28, the formulation ratio may be applied to the aggregate form, to a graphene-only fraction within the aggregate, or to the combined graphene material introduced into the mixture 34, with the selected definition maintained consistently across manufacturing lots for repeatable performance.

In some aspects, the ratio among the volume of turbostratic layered non-functionalized graphene 26, the volume of activated carbon 24, and the binder 30 is adjustable to tune manufacturability and electrical performance while maintaining a target pore structure for electrolyte 22 infiltration. For example, the turbostratic layered non-functionalized graphene 26 fraction may be increased to further reduce internal resistance and improve pulse power capability, or reduced to preserve a higher fraction of activated carbon surface area where maximizing gravimetric or volumetric capacitance is prioritized. Similarly, the binder 30 fraction may be adjusted to improve coating integrity, reduce dusting, improve adhesion to the first current collector 44 and the second current collector 46, and support winding or stacking operations, while maintaining sufficient pore accessibility so that the electrolyte 22 saturates the electrode thickness and maintains ionic conduction pathways. In these aspects, ratio selection is coordinated with electrode thickness, calendaring density, separator 20 selection, and electrolyte 22 properties so that the electrochemical energy storage system 10 maintains both low equivalent series resistance and consistent capacitance under high-rate cycling.

In certain aspects, the ratio of turbostratic layered non-functionalized graphene 26, activated carbon 24, and binder 30 is selected to provide a specific capacitance in a range of 160 F g⁻¹ to 180 F g⁻¹ for an electrode formed from the composite formulation, measured under a defined electrochemical test protocol selected for supercapacitor characterization. In these aspects, the turbostratic layered non-functionalized graphene 26 contributes conductive pathways and microstructural features that support improved utilization of activated carbon surface area under high-rate conditions, thereby improving apparent capacitance retention during rapid charge and discharge relative to activated carbon-based electrodes. Where multiple electrode layers are used in a stacked or wound construction, the formulation ratio may be maintained consistently across the plurality of electrodes to promote uniform aging and uniform current distribution, or the ratio may be intentionally adjusted between layers to shape impedance distribution and thermal behavior across the stack.

The second electrode 16 may be constructed in the same manner as the first electrode 12, particularly when the electrochemical energy storage system 10 is configured as a symmetric supercapacitor system in which balanced charge storage and balanced impedance are maintained between opposing electrodes. The second electrode 16 may include the second electrode layer 48 supported on the second current collector 46, with the second electrode layer 48 configured as a porous, electronically conductive layer that supports ionic access from the electrolyte 22 throughout a thickness of the second electrode layer 48. The second electrode 16 may be formed as a planar sheet, a patterned sheet, a segmented sheet, or a shaped sheet depending on the package format of the electrochemical energy storage system 10, including circular geometries for coin or button formats, rectangular or square geometries for stacked pouch and prismatic formats, and elongated strip geometries for wound jelly-roll formats. The second electrode layer 48 of the second electrode 16 may be configured with substantially uniform thickness across an active area or may include densified regions, edge tapering, graded porosity, or patterned micro-features selected to manage current distribution, reduce edge effects, improve electrolyte 22 infiltration, or reduce localized heating during high pulse operation.

The second electrode layer 48 of the second electrode 16 may include the volume of activated carbon 24 that provides high internal surface area and a pore network that supports electric double-layer formation at a carbon-electrolyte interface. The volume of activated carbon 24 included in the second electrode 16 may be selected using the same considerations described for the first electrode 12, including specific surface area, pore size distribution, ash content, moisture content, particle mechanical integrity, and compatibility with the electrolyte 22. The volume of activated carbon 24 may function as a porous matrix in which the electrolyte 22 penetrates and wets internal pore surfaces, and a pore structure may include a combination of micro-pores that provide high charge storage surface area and meso- and macro-pores that support electrolyte transport during high-rate charge and discharge. The volume of activated carbon 24 may be supplied as a powder having a particle size distribution selected to provide uniform coating behavior, stable mechanical cohesion after drying, and predictable porosity after calendaring.

The second electrode layer 48 of the second electrode 16 may further include the volume of turbostratic layered non-functionalized graphene 26 to improve electronic conductivity pathways and to support formation of conductive percolation networks within the volume of activated carbon 24. The volume of turbostratic layered non-functionalized graphene 26 may be incorporated as a powder additive that disperses throughout the volume of activated carbon 24 and bridges activated carbon particles to reduce internal resistance, thereby improving high-power response of the electrochemical energy storage system 10. The volume of turbostratic layered non-functionalized graphene 26 may be selected to be non-functionalized to support stability in organic electrolytes and to limit undesired side reactions, and a turbostratic character may be characterized by rotational misalignment between adjacent graphene layers rather than strict Bernal stacking, which can influence accessibility and restacking behavior within a composite electrode microstructure. An amount of the volume of turbostratic layered non-functionalized graphene 26 may be selected as a relatively low fraction compared to the volume of activated carbon 24 so that conductivity is improved while the volume of activated carbon 24 remains a dominant contributor to accessible surface area.

In some configurations, the volume of turbostratic layered non-functionalized graphene 26 included in the second electrode layer 48 of the second electrode 16 includes the volume of turbostratic layered non-functionalized graphene aggregate 28 dispersed in the volume of activated carbon 24. The volume of turbostratic layered non-functionalized graphene aggregate 28 may provide a hierarchical, multi-scale morphology that supports conductive connectivity at relatively low loading and provides processable powder handling during manufacturing. The volume of turbostratic layered non-functionalized graphene aggregate 28 may include few-layer primary structures assembled into secondary aggregates that distribute within an activated carbon matrix and interact with the binder 30 to maintain conductive networks after drying. The volume of turbostratic layered non-functionalized graphene aggregate 28 may include predominantly sp2-bonded carbon and may have an elemental carbon purity at or above about 95 weight percent, supporting high conductivity and consistent electrochemical behavior. When the volume of turbostratic layered non-functionalized graphene aggregate 28 is used in the second electrode 16, the volume of turbostratic layered non-functionalized graphene aggregate 28 may be selected to coordinate with a formulation used in the first electrode 12 so that overall device symmetry and impedance balance are maintained, or the volume of turbostratic layered non-functionalized graphene aggregate 28 may be intentionally adjusted to tune a resistance contribution or a capacitance contribution of the second electrode 16.

The second electrode 16 may include the binder 30 selected to provide mechanical integrity, cohesion among the volume of activated carbon 24 and the volume of turbostratic layered non-functionalized graphene 26, and adhesion of the second electrode layer 48 to the second current collector 46. The binder 30 may be a polymer binder, including polyvinylpyrrolidone, polyvinyl alcohol, or a combination thereof, selected to provide durability and adhesion similar to the first electrode 12 while maintaining compatibility with the electrolyte 22. Polyvinylpyrrolidone may support dispersion stabilization and coating uniformity in solvent systems used to form the slurry 38, while polyvinyl alcohol may provide film-forming behavior and mechanical robustness that supports winding, stacking, and compression assembly without cracking or delamination. A fraction of the binder 30 in the second electrode 16 may be selected to balance mechanical integrity with electrical and ionic performance, typically remaining a minor fraction of total dried solids so that pore accessibility and conductivity pathways are preserved. The binder 30 may be distributed uniformly within the second electrode layer 48 or the binder 30 concentration may be graded to provide higher binder concentration near an interface with the second current collector 46 for improved adhesion while preserving higher porosity and higher accessible surface area near an electrolyte-facing region of the second electrode layer 48.

In some aspects, the binder 30 is introduced at a controlled percentage relative to the volume of activated carbon 24 to support repeatable slurry rheology and repeatable mechanical integrity after drying. For example, the binder 30 may be added at a percentage of about 4 percent of the mass of the activated carbon used for the mixture 34, with the percentage selected to provide sufficient cohesion among activated carbon particles and the turbostratic layered non-functionalized graphene material while limiting pore blockage that would increase ionic resistance. In these aspects, binder percentage control supports consistent coating behavior during formation of the slurry 38, including stable viscosity for deposition by spray coating, doctor blading, or related approaches, and consistent adhesion of the dried electrode layer to the first current collector 44 or the second current collector 46. When polyvinylpyrrolidone is used as the binder 30, the binder fraction may also support stabilization of dispersion during mixing, reducing re-agglomeration of the turbostratic layered non-functionalized graphene 26 or the turbostratic layered non-functionalized graphene aggregate 28 prior to deposition.

In symmetric configurations, the first electrode 12 and the second electrode 16 are matched in thickness and mass loading to maintain balanced charge storage, uniform current distribution, and consistent aging behavior across both electrodes. Matching may include selecting the same thickness for the first electrode layer 40 and the second electrode layer 48, selecting the same formulation ratios among the volume of activated carbon 24, the volume of turbostratic layered non-functionalized graphene 26 or the volume of turbostratic layered non-functionalized graphene aggregate 28, and the binder 30, and using similar calendaring conditions to achieve similar density and porosity. Such matching can reduce a risk of one electrode limiting an overall capacitance or driving uneven voltage distribution within the electrochemical energy storage system 10. In other configurations, one of the first electrode 12 or the second electrode 16 may be adjusted relative to the other to tune device performance. Adjustments may include altering thickness of the first electrode layer 40 or altering thickness of the second electrode layer 48, altering density by calendaring to change porosity and ionic accessibility, altering mass loading to change areal capacitance, or altering a fraction of conductive additive to change resistance. Such tuning may be used to optimize performance for duty cycles that emphasize extremely high-power pulses, frequent regenerative capture events, high temperature operation, low temperature operation, or reduced leakage behavior. Adjustments may also be used to mitigate aging effects, for example by providing additional accessible surface area margin on one electrode, or by adjusting porosity and conductivity to maintain acceptable impedance as the electrochemical energy storage system 10 cycles over life.

The first current collector 44 supporting the first electrode 12 and the second current collector 46 supporting the second electrode 16 may each be selected based on electrical conductivity, corrosion resistance in the electrolyte 22, mechanical strength, manufacturability, and compatibility with coating and thermal processing used to form the first electrode layer 40 and the second electrode layer 48. The first current collector 44 and the second current collector 46 each function as a primary electronic conduction pathway for the respective electrode, collecting and distributing current across an active area so that the first electrode layer 40 and the second electrode layer 48 deliver high pulse power with low resistive loss. Material selection for the first current collector 44 and the second current collector 46 may account for an operating voltage window, a chemical environment created by the electrolyte 22, and a joining approach for external terminals, tabs, or leads. Each of the first current collector 44 and the second current collector 46 may be implemented as a foil, sheet, mesh, expanded metal, perforated metal, metal grid, or a composite collector structure, with geometry selected to provide adequate stiffness for handling and assembly while minimizing mass and internal resistance.

Suitable materials for the first current collector 44 and the second current collector 46 include stainless steel, aluminum, nickel, titanium, conductive carbon papers, and other conductive substrates that remain stable in contact with the electrolyte 22. Stainless steel used for the first current collector 44 or the second current collector 46 may be useful in laboratory-scale electrodes and certain device formats due to robustness, availability, and ease of handling during prototype fabrication. Aluminum foil used for the first current collector 44 or the second current collector 46 is commonly used in organic-electrolyte supercapacitors due to low density and good electrical conductivity, and aluminum may be supplied in roll form for high-throughput coating. Nickel foil or nickel mesh used for the first current collector 44 or the second current collector 46 may be used where additional corrosion resistance, mechanical toughness, or welding compatibility is desired, including designs that rely on tab welding, busbar welding, or module interconnect welding. Titanium used for the first current collector 44 or the second current collector 46 may be used where enhanced corrosion resistance is prioritized, including higher temperature conditions, provided that surface preparation and joining approaches address oxide formation and contact resistance. Conductive carbon papers or conductive carbon cloth used for the first current collector 44 or the second current collector 46 may be used where low mass, high corrosion resistance, or flexibility is desired, and such collectors may be paired with conductive coatings or impregnation layers to reduce contact resistance at an interface with the first electrode layer 40 or an interface with the second electrode layer 48.

The thickness of the first current collector 44 and the thickness of the second current collector 46 may each range from a few micrometers for thin foils to hundreds of micrometers for rigid sheets, depending on the device format of the electrochemical energy storage system 10 and mechanical support needed during assembly. Thin foils used for the first current collector 44 and the second current collector 46 may support wound jelly-roll architectures where flexibility and gravimetric performance are important. Thicker sheets used for the first current collector 44 and the second current collector 46 may support stacked laminates, compression frames, rigid prismatic formats, or prototype constructions that rely on clamped connections and repeated disassembly. Meshes, expanded metals, and perforated structures used for the first current collector 44 or the second current collector 46 may improve mechanical interlocking with the first electrode layer 40 or the second electrode layer 48, increase effective bonding area, reduce delamination risk, and in some configurations improve electrolyte access at an interface with the collector. The first current collector 44 and the second current collector 46 may each include edge margins, uncoated regions, tab regions, or terminal regions reserved for electrical joining, with those regions positioned to manage electrical clearance and to reduce undesired exposure of joining regions to the electrolyte 22 when such exposure is not desired.

The first current collector 44 and the second current collector 46 may each include surface treatments selected to improve adhesion of the first electrode layer 40 and the second electrode layer 48 and to reduce contact resistance at the respective interfaces. Surface treatments for the first current collector 44 or the second current collector 46 may include roughening, etching, embossing, brushing, chemical conversion layers, carbon coatings, conductive polymer coatings, or controlled oxide layers that stabilize a surface while maintaining low interfacial resistance. Roughening or etching of the first current collector 44 or the second current collector 46 may create micro-texture that increases mechanical interlock and improves peel strength, reducing the likelihood of electrode lift during calendaring or cycling. Carbon coatings on the first current collector 44 or the second current collector 46 may provide a conductive interfacial layer that reduces sensitivity to native oxide films and improves uniform current distribution across the interface. Oxide control layers on the first current collector 44 or the second current collector 46 may manage thickness and uniformity of surface oxides, including on aluminum-based collectors, to avoid localized high resistance regions while still supporting corrosion resistance in the electrolyte 22.

Electrical connection to the first current collector 44 and electrical connection to the second current collector 46 may each be provided by a tab, a terminal, or a lead structure coupled to the respective collector. The connection to the first current collector 44 and the connection to the second current collector 46 may each be formed by welding, riveting, crimping, brazing, soldering where compatible, conductive adhesives, or mechanical clamping, with an approach selected based on collector material, device format, and target current. In wound and stacked architectures, tab geometry and tab placement for the first current collector 44 and the second current collector 46 may be arranged to minimize resistive path length and reduce current crowding, including using multiple tab locations along an edge or distributing tabs to balance current collection. Tab patterning and tab placement for the first current collector 44 and the second current collector 46 may also be selected to control thermal distribution during high-rate operation, reducing localized heating and improving reliability during repeated pulse events. The first current collector 44 and the second current collector 46 may each further include alignment features such as registration holes, notches, fiducials, or patterned cutouts used to index the first electrode 12, the second electrode 16, the separator 20, or combinations thereof during stacking or winding.

The second current collector 46 may be of the same material as the first current collector 44 when symmetry and manufacturing simplicity are prioritized, or the second current collector 46 may be selected differently based on packaging constraints, corrosion considerations, or electrical joining requirements. For example, one collector may be selected for enhanced weldability to a specific terminal design while the other is selected for lower mass or different mechanical stiffness, provided both remain compatible with the electrolyte 22 and operating conditions. The second current collector 46 may include tabs or terminal regions that are left uncoated to facilitate joining to external circuitry, and tab geometry and placement may be selected to minimize resistive path length and reduce current crowding during high-rate operation. The second current collector 46 may be treated or textured to improve coating adhesion and reduce contact resistance, including surface roughening, etching, embossing, carbon coatings, conductive polymer interface layers, or oxide control approaches that produce consistent interfacial properties. In this manner, the second electrode 16 may cooperate with the first electrode 12 to provide a stable, low-resistance, high-power capacitive storage architecture within the electrochemical energy storage system 10.

The separator 20 is disposed between the first electrode 12 and the second electrode 16 and is selected to physically prevent direct electronic contact between the first electrode 12 and the second electrode 16 while allowing ionic transport through the electrolyte 22. The separator 20 functions as an electronically insulating barrier that maintains electrical isolation during manufacturing, assembly compression, vibration, and cycling, while remaining permeable to ions so that the electrolyte 22 supports charge and discharge of the electrochemical energy storage system 10. The separator 20 may be sized and shaped to correspond to an active area of the first electrode 12 and an active area of the second electrode 16, with a margin beyond electrode edges selected to reduce edge-short risk and provide a buffer region for alignment tolerances. In wound jellyroll formats, the separator 20 may be provided as a continuous strip that wraps around electrode edges to prevent edge contact during winding and to maintain separation between adjacent layers, and a length and a width of the separator 20 may be selected to accommodate winding diameter, core size, and tab placement without wrinkling or tearing.

In some aspects, the separator 20 is a porous cellulose-based separator. A cellulose-based separator may provide high electrolyte uptake and favorable wetting in organic electrolytes, helping the electrolyte 22 infiltrate and remain distributed through a thickness of the separator 20 to maintain stable ionic conduction. Cellulose-based separators may also provide mechanical strength for handling and assembly while remaining compliant enough to conform to electrode surface topography under compression, thereby improving interfacial contact and reducing local gaps that increase ionic resistance. In addition, cellulose-based separators may be selected for consistent pore structure and for compatibility with manufacturing processes that include vacuum electrolyte 22 filling and extended wetting periods.

A thickness of the separator 20 may be selected to balance low ionic resistance and robust short-circuit prevention. Thinner separator 20 constructions generally reduce ionic path length and lower internal resistance, supporting high power operation, while thicker separator 20 constructions generally provide greater puncture resistance, improved tolerance to particles or edge burrs, and greater robustness during winding and compression assembly. For example, the thickness of the separator 20 may be selected in a range of tens of micrometers to a few hundreds of micrometers, with a target thickness coordinated with a thickness of the first electrode layer 40, a thickness of the second electrode layer 48, calendaring density, and expected operating pressure so that the separator 20 maintains integrity without excessive compression that could collapse pores. In some configurations, the separator 20 is selected to maintain stable thickness under compressive load and thermal cycling, thereby preserving consistent ionic resistance over life of the electrochemical energy storage system 10.

The separator 20 may be implemented as a nonwoven sheet, a paper-like sheet, a microporous film, or a composite laminate. A nonwoven sheet may provide a tortuous, interconnected pore network with high electrolyte 22 uptake and puncture resistance. A paper-like sheet may provide a uniform fibrous structure with controlled thickness and favorable handling properties. A microporous film may provide a more uniform pore size distribution and can be engineered with specific porosity and mechanical properties. Composite laminates may combine layers that serve different roles, such as a base layer that provides mechanical strength and an interface layer that improves wetting or reduces pore collapse under compression. The separator 20 may also include edge treatments or reinforcement regions that reduce tearing during winding and reduce a likelihood of separator damage at sharp corners or near tab regions.

In other aspects, the separator 20 may be formed from polypropylene, polyethylene, polypropylene-polyethylene multilayers, glass fiber, polyimide, aramid fibers, or ceramic-coated separators that improve thermal stability and puncture resistance. Polypropylene and polyethylene separators may provide chemical stability in organic electrolytes and can be engineered as microporous films that balance thickness, porosity, and tensile strength. Multilayer polypropylene-polyethylene separators may provide improved mechanical robustness and can be engineered for shutdown behavior in certain battery contexts, and similar multilayer structures may be selected when thermal response characteristics are desired. Glass fiber separators may provide high temperature stability and high electrolyte 22 uptake, which can be useful where elevated temperature operation or high thermal robustness is required. Polyimide separators may provide thermal stability and mechanical strength, supporting operation in demanding temperature environments. Aramid fiber separators may provide puncture resistance and dimensional stability, which can be beneficial in high compression assemblies or high vibration environments. Ceramic-coated separators may include an inorganic coating that improves puncture resistance, reduces shrinkage at elevated temperatures, and provides thermal stability, with the coating selected to maintain ionic permeability and wetting with the electrolyte 22.

Porosity and pore size distribution of the separator 20 may be selected to support rapid ion transport and maintain uniform ionic flux during high current operation. Higher porosity generally reduces ionic resistance but may reduce mechanical strength if not properly engineered, while lower porosity may increase mechanical robustness but may increase ionic resistance and reduce high-rate performance. Pore size distribution may be selected to allow efficient ion movement while preventing passage of particles large enough to create local shorts, and the separator 20 may be designed to avoid defects or pinholes that could compromise electrical isolation. The separator 20 may also be selected to minimize thickness variation and to maintain consistent pore structure across an area, which supports uniform current distribution and reduces localized heating. In some aspects, the separator 20 is configured to prevent short-circuiting between the first electrode 12 and the second electrode 16 by maintaining electronic insulation across the electrode interface while allowing ionic movement through the separator thickness in the presence of the electrolyte 22. In these aspects, the separator 20 provides a physical barrier that resists puncture and edge contact under compression while remaining sufficiently porous for ion transport so charge and discharge occur through ionic migration and electric double-layer formation at electrolyte-accessible carbon surfaces.

The separator 20 may be selected for low extractables, low ash content, and chemical stability with the volume of tetraethylammonium tetrafluoroborate (TEABF4) in acetonitrile (ACN). Low extractables can reduce contamination of the electrolyte 22 and reduce risk of increased leakage current or gas generation over time. Low ash content can reduce inorganic residues that might catalyze side reactions or deposit at electrode interfaces. Chemical stability includes resistance to swelling, dissolution, embrittlement, or pore structure collapse when exposed to the electrolyte 22 under operating voltage and temperature conditions of the electrochemical energy storage system 10. In this manner, the separator 20 maintains reliable physical separation of the first electrode 12 and the second electrode 16 while allowing ionic transport needed for high-power supercapacitor operation.

The electrolyte 22 provides an ion-conducting medium for charge storage and transport within the electrochemical energy storage system 10. The electrolyte 22 is in ionic communication with the first electrode 12 and the second electrode 16, penetrates and wets pore networks within the first electrode layer 40 and the second electrode layer 48, and saturates the separator 20 so that ions migrate between the first electrode 12 and the second electrode 16 during charging and discharging. In operation, the electrolyte 22 supplies mobile ionic species that accumulate at electrolyte-accessible carbon surfaces within the volume of activated carbon 24 and at surfaces associated with the volume of turbostratic layered non-functionalized graphene 26, allowing formation of electric double layers and supporting rapid, reversible charge storage characteristic of supercapacitor behavior. The electrolyte 22 may be selected to provide ionic conductivity, chemical stability within an operating voltage window, low viscosity for fast ion transport, and wetting behavior across the first electrode layer 40, the second electrode layer 48, and the separator 20, particularly during high-rate pulse operation where ionic transport limitations can otherwise increase equivalent series resistance and reduce usable capacitance.

In some aspects, the electrolyte 22 includes the volume of tetraethylammonium tetrafluoroborate (TEABF₄) in acetonitrile (ACN). The volume of tetraethylammonium tetrafluoroborate (TEABF₄) in acetonitrile (ACN) may be formulated so that tetraethylammonium tetrafluoroborate (TEABF₄) salt is present at a concentration suitable for ionic conductivity and stable electrochemical operation. Concentrations around one molar in acetonitrile (ACN) may be used, and other concentrations may be selected based on temperature range, conductivity targets, viscosity targets, and desired low-temperature or high-temperature performance. Higher concentrations may increase a number of charge carriers but may also increase viscosity and reduce mobility, while lower concentrations may reduce viscosity but may reduce ionic conductivity, and a selected concentration may be tuned to a duty cycle and internal geometry of the electrochemical energy storage system 10. The electrolyte 22 may also be formulated to maintain performance across an expected operating temperature range by selecting salt concentration and purity that reduce crystallization risk, reduce viscosity rise at low temperature, and reduce volatility-related effects at elevated temperature.

The low viscosity of acetonitrile (ACN) can improve infiltration and wetting of micro-porous structures within the volume of activated carbon 24 and can reduce diffusion limitations in the first electrode layer 40 and the second electrode layer 48 during rapid pulses. A solvent system may also be selected to provide stable interfacial behavior at carbon surfaces and to limit side reactions that could increase leakage current, generate gas, or raise internal resistance over time. Purity of acetonitrile (ACN) and purity of tetraethylammonium tetrafluoroborate (TEABF4) salt may be controlled to reduce water content and other contaminants that influence voltage stability and aging, and packaging approaches may be selected to limit moisture ingress during storage and operation.

The electrolyte 22 may be introduced into the electrochemical energy storage system 10 by vacuum filling, soaking, or metered injection, followed by a wetting period that allows the electrolyte 22 to infiltrate the first electrode layer 40, the second electrode layer 48, and the separator 20. Vacuum filling may remove trapped gases from pores and allow the electrolyte 22 to rapidly penetrate through full thickness of the first electrode layer 40, through full thickness of the second electrode layer 48, and through the separator 20, which can be beneficial for thick electrode constructions or tight pore structures. Soaking approaches may allow gradual wetting and equilibration, with fill time selected so the electrolyte 22 reaches internal micro-pores that contribute to capacitance. Metered injection may be used in pouch and prismatic formats to deliver a controlled amount of electrolyte 22, with subsequent rest periods and gentle agitation optionally used to distribute the electrolyte 22 uniformly. The wetting period may be coordinated with compression applied to an electrode stack formed by the first electrode 12, the separator 20, and the second electrode 16, because compression can influence pore volume and electrolyte 22 distribution, and the wetting period may be selected to minimize dry regions that increase internal resistance and reduce performance consistency.

In some aspects, electrolyte 22 additives may be included in small quantities to improve stability, reduce gas generation, or modify interfacial behavior, while maintaining compatibility with the volume of activated carbon 24 and the volume of turbostratic layered non-functionalized graphene aggregate 28. Additives may be selected to scavenge trace moisture, inhibit decomposition reactions, stabilize a double-layer interface, or reduce impurity-driven reactions that contribute to self-discharge. Additives may also be selected to maintain stable wetting and minimize changes to viscosity or conductivity that would otherwise reduce high-rate performance. When additives are used, concentration may be controlled so that the electrolyte 22 maintains ionic conductivity and does not significantly block electrolyte 22 access to micro-porous regions of the first electrode layer 40 and the second electrode layer 48.

The electrolyte 22 may be selected to support an operating voltage window appropriate for organic electrolytes, with the electrochemical energy storage system 10 designed to maintain that operating voltage window during charge, discharge, and balancing operations. The operating voltage window may be coordinated with purity of the electrolyte 22, the separator 20, and stability of electrode materials so that long-term cycling does not cause rapid resistance rise or excessive gas generation. Device packaging may include venting or pressure management features appropriate for long-term cycling and for extreme operating events, including vent structures, burst disks, or controlled relief features configured to manage internal pressure while maintaining safe operation. In this manner, the electrolyte 22 provides a stable, high-conductivity ionic pathway that supports high-power, fast-response performance of the electrochemical energy storage system 10.

In aspects, the electrochemical energy storage system 10 uses a plurality of electrodes where formulation ratios are controlled on a per-layer basis to achieve consistent electrical behavior across the stack. In a symmetric stack, each first electrode layer 40 and each second electrode layer 48 may be formed using a common formulation, such as maintaining the same ratio among the volume of activated carbon 24, the volume of turbostratic layered non-functionalized graphene 26 or the volume of turbostratic layered non-functionalized graphene aggregate 28, and the binder 30, and maintaining a common areal loading and calendaring density so that charge storage and impedance are balanced. In other aspects, one or more layers are intentionally formulated differently to tune a desired property, including reducing resistance in layers expected to carry higher current density near tab regions, increasing binder fraction in layers expected to experience higher mechanical stress during winding, or altering the turbostratic layered non-functionalized graphene fraction to shape conductivity gradients through thickness. These approaches may be used to reduce localized heating, improve current distribution, and preserve capacitance under high pulse conditions while maintaining separator 20 integrity and electrolyte 22 access throughout the plurality of electrodes.

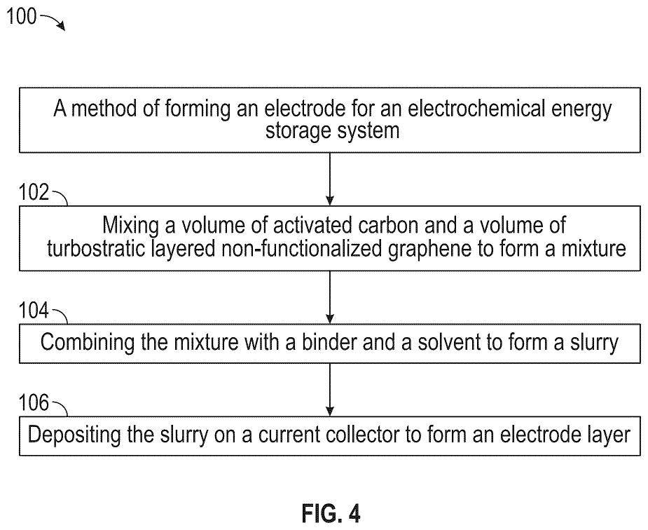

Referring to FIG. 4, a method 100 for forming a composite electrode layer is shown for the electrochemical energy storage system 10. The method 100 is directed to preparing a carbon-based electrode formulation that combines the volume of activated carbon 24 with the volume of turbostratic layered non-functionalized graphene 26, converting the formulation into the slurry 38 using the binder 30 and the solvent 36, and depositing the slurry 38 onto the first current collector 44 or the second current collector 46 to form a composite electrode layer. In aspects, the deposited composite electrode layer forms a first electrode layer 40 corresponding to the first electrode 12 when deposited on the first current collector 44, and the deposited composite electrode layer forms a second electrode layer 48 corresponding to the second electrode 16 when deposited on the second current collector 46. The method 100 may be used to fabricate an electrode for a supercapacitor system in which rapid charge and discharge, low equivalent series resistance, and stable cycling are supported through a porous carbon microstructure and high ionic access from the electrolyte 22.

Block 102 includes mixing the volume of activated carbon 24 and the volume of turbostratic layered non-functionalized graphene 26 to form the mixture 34. Mixing may be performed using dry blending, high-shear mixing, planetary mixing, ball milling, or other mechanical mixing approaches selected to distribute the volume of turbostratic layered non-functionalized graphene 26 throughout the volume of activated carbon 24 while limiting formation of persistent clumps. The mixing conditions may be selected to achieve a target dispersion state in which the volume of turbostratic layered non-functionalized graphene 26 bridges activated carbon particles and promotes conductive connectivity without excessively collapsing pore structure or generating excessive fines that impair coating quality. In some implementations, the volume of turbostratic layered non-functionalized graphene 26 includes the volume of turbostratic layered non-functionalized graphene aggregate 28 dispersed within the volume of activated carbon 24, and the volume of turbostratic layered non-functionalized graphene aggregate 28 may be incorporated as a processable powder that distributes through mechanical mixing without the use of surfactants. The volume of turbostratic layered non-functionalized graphene aggregate 28 may be selected so that the volume of turbostratic layered non-functionalized graphene aggregate 28 has an elemental carbon purity of at least about 95 weight percent and includes sp2-bonded carbon, thereby supporting high electronic conductivity and stable electrochemical behavior in the first electrode layer 40 and the second electrode layer 48. In certain implementations, the volume of turbostratic layered non-functionalized graphene aggregate 28 is produced by an explosion or detonation process, and the explosion or detonation process is performed within the sealed constant-volume chamber 42. Production within the sealed constant-volume chamber 42 may support consistent morphology and consistent layered carbon character of the volume of turbostratic layered non-functionalized graphene aggregate 28, and the produced powder may be collected and conditioned for incorporation into the mixture 34 prior to forming the slurry 38.

Block 104 includes combining the mixture 34 with the binder 30 and the solvent 36 to form the slurry 38. The binder 30 may be selected to provide cohesion among the volume of activated carbon 24 and the volume of turbostratic layered non-functionalized graphene 26 and to provide adhesion of the first electrode layer 40 to the first current collector 44 and adhesion of the second electrode layer 48 to the second current collector 46 after deposition and drying. The binder 30 may be a polymer binder, including polyvinylpyrrolidone, polyvinyl alcohol, or a combination thereof, and the polymer binder selection may be coordinated with the solvent 36 to achieve a stable slurry viscosity and a coating rheology suitable for the selected deposition technique. The solvent 36 may be selected to wet the volume of activated carbon 24 and the volume of turbostratic layered non-functionalized graphene 26, dissolve or disperse the binder 30, and produce the slurry 38 with flow behavior suitable for uniform coating. The slurry 38 may be mixed under controlled shear and time to reduce agglomerates, to distribute the binder 30 throughout the carbon network, and to achieve uniform solids distribution and repeatable viscosity. In some implementations, the solids ratio among the volume of activated carbon 24, the volume of turbostratic layered non-functionalized graphene 26 or the volume of turbostratic layered non-functionalized graphene aggregate 28, and the binder 30 is selected so that the volume of activated carbon 24 remains the dominant surface-area component, the volume of turbostratic layered non-functionalized graphene 26 contributes conductive connectivity as an additive, and the binder 30 remains a minor fraction used primarily for mechanical integrity and adhesion. The slurry 38 may be conditioned by degassing, filtration, or controlled rest periods to reduce entrained air and to improve coating uniformity, particularly when the first electrode layer 40 and the second electrode layer 48 are formed as thin, high-quality films.

Block 106 includes depositing the slurry 38 on the first current collector 44 or the second current collector 46 to form the first electrode layer 40 or the second electrode layer 48. Deposition may be performed by doctor blading, slot-die coating, roll coating, spray coating, screen printing, stencil printing, gravure coating, or related deposition approaches selected for laboratory fabrication or roll-to-roll manufacturing. The deposition conditions may be selected to control wet thickness, coating uniformity, edge definition, and mass loading, and to produce the first electrode layer 40 and the second electrode layer 48 having target dried thickness and porosity consistent with power and energy targets for the electrochemical energy storage system 10.

Following deposition, the first electrode layer 40 and the second electrode layer 48 may be dried to remove the solvent 36 under controlled temperature, time, and atmosphere conditions selected to preserve pore structure, maintain adhesion to the first current collector 44 or the second current collector 46, and avoid cracking or delamination. The first electrode layer 40 and the second electrode layer 48 may be calendared after drying to adjust density and porosity, with calendaring conditions selected to improve particle-to-particle contact and reduce contact resistance while maintaining electrolyte infiltration pathways. The formed first electrode layer 40 and second electrode layer 48 may then be cut, wound, or stacked to form the first electrode 12, the second electrode 16, or both, for assembly with the separator 20 and subsequent introduction of the electrolyte 22.

The method 100 may further include forming the electrolyte 22 so that the electrolyte 22 includes the volume of tetraethylammonium tetrafluoroborate (TEABF₄) in acetonitrile (ACN), with concentration selected to provide high ionic conductivity and stable operation. The electrolyte 22 may be introduced during assembly of the electrochemical energy storage system 10 so that the electrolyte 22 infiltrates the first electrode layer 40, the second electrode layer 48, and the separator 20 and establishes ionic communication between the first electrode 12 and the second electrode 16. When the electrochemical energy storage system 10 is implemented as a supercapacitor system, the first electrode layer 40 and the second electrode layer 48 formed by the method 100 support rapid charge and discharge through electric double-layer behavior at electrolyte-accessible carbon surfaces, while conductive connectivity provided by the volume of turbostratic layered non-functionalized graphene 26 or the volume of turbostratic layered non-functionalized graphene aggregate 28 supports low internal resistance and high pulse power response.

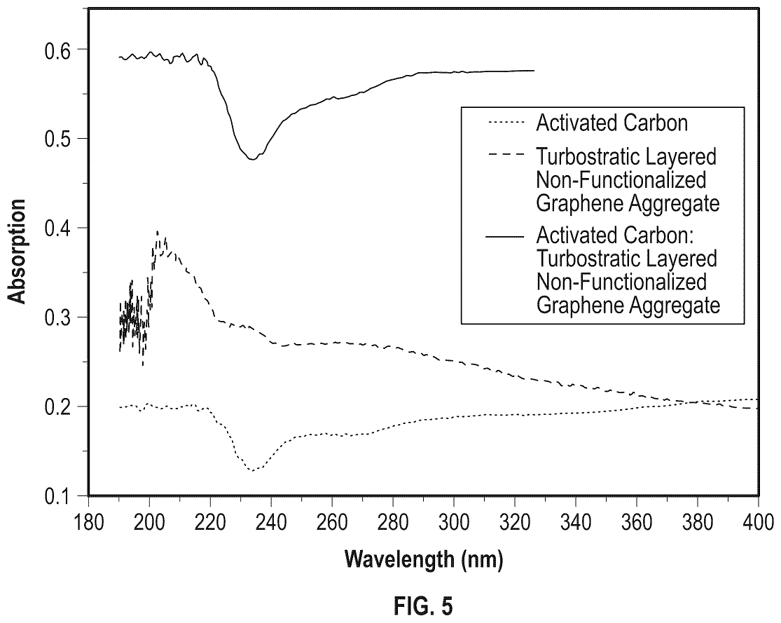

Referring now to FIG. 5, ultraviolet-visible absorption spectra are illustrated for the volume of activated carbon 24, the volume of turbostratic layered non-functionalized graphene aggregate 28, and a composite formed by combining the volume of activated carbon 24 with the volume of turbostratic layered non-functionalized graphene aggregate 28. The volume of activated carbon 24 exhibits an absorption peak at about 199.4 nanometers with an absorbance of about 0.205, and the volume of turbostratic layered non-functionalized graphene aggregate 28 exhibits an absorption peak at about 202.2 nanometers with an absorbance of about 0.397. The composite formed by combining the volume of activated carbon 24 with the volume of turbostratic layered non-functionalized graphene aggregate 28 exhibits an absorption peak at about 190.4 nanometers with an absorbance of about 0.593. The composite absorbance of about 0.593 is close to a sum of the individual absorbances of about 0.205 and about 0.397, which together total about 0.602, indicating that the combined material exhibits an additive optical response consistent with the composite behaving as an integrated material rather than merely a physical superposition of separate powders under the measurement conditions.

The ultraviolet-visible absorption behavior shown in FIG. 5 is consistent with a composite microstructure in which the volume of turbostratic layered non-functionalized graphene aggregate 28 is dispersed within the volume of activated carbon 24 to form a mixed carbon network suitable for incorporation into the first electrode layer 40 of the first electrode 12, the second electrode layer 48 of the second electrode 16, or both. The observed shift in the composite peak toward a shorter wavelength relative to the individual components may be associated with interactions that occur when the volume of activated carbon 24 and the volume of turbostratic layered non-functionalized graphene aggregate 28 are combined, including interfacial contact between carbon domains and distribution of the volume of turbostratic layered non-functionalized graphene aggregate 28 throughout activated carbon interparticle regions. The additive absorbance behavior further supports selecting processing conditions that promote stable distribution of the volume of turbostratic layered non-functionalized graphene aggregate 28 within the volume of activated carbon 24 during formation of the mixture 34 and subsequent formation of the slurry 38, thereby supporting uniform deposition of the slurry 38 onto the first current collector 44 or the second current collector 46 to form the first electrode layer 40 or the second electrode layer 48 with predictable composition and performance.

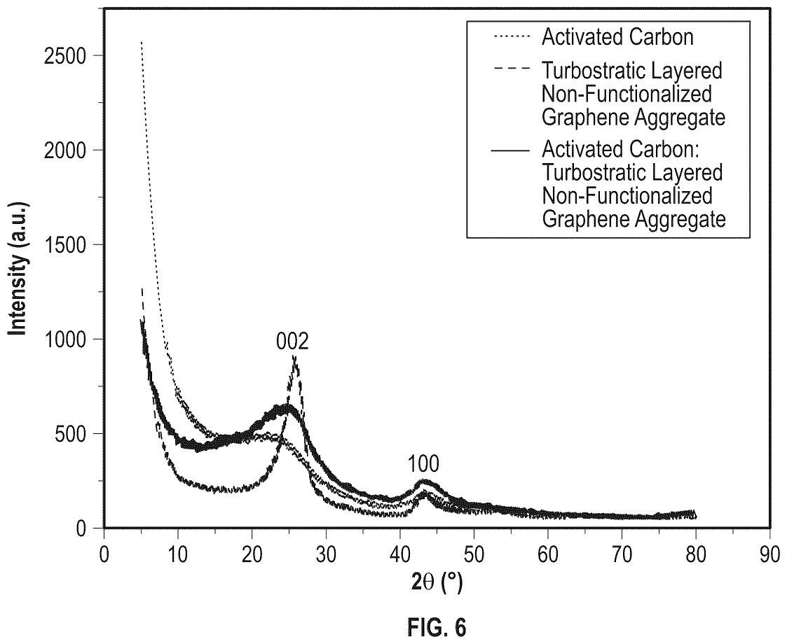

Referring now to FIG. 6, X-ray diffraction patterns are illustrated for the volume of activated carbon 24, the volume of turbostratic layered non-functionalized graphene aggregate 28, and the composite formed by combining the volume of activated carbon 24 with the volume of turbostratic layered non-functionalized graphene aggregate 28. Each diffraction pattern exhibits two broad peaks near about 19 degrees and about 43 degrees, which correspond to the (002) and (100) planes of graphite. The breadth of these peaks is consistent with carbon materials that exhibit limited long-range order, including microcrystalline domains and turbostratic stacking, and is consistent with a porous and partially amorphous character of the volume of activated carbon 24 and a layered but rotationally misaligned character of the volume of turbostratic layered non-functionalized graphene aggregate 28. In this manner, the diffraction response supports that the composite retains carbon-phase characteristics associated with the starting materials while presenting a combined diffraction signature attributable to the mixed carbon architecture.

The diffraction pattern of the composite shows an apparent shift in the (002) peak position relative to the individual materials. This behavior is consistent with overlap between a broad, more amorphous (002)-associated feature contributed by the volume of activated carbon 24 and a comparatively sharper (002)-associated feature contributed by the volume of turbostratic layered non-functionalized graphene aggregate 28. When these features overlap in the composite, the resulting peak position and shape can reflect contributions from both components rather than indicating that a new crystalline phase has formed. Because the process used to form the composite may be a relatively benign mixing process during formation of the mixture 34, major structural changes to the volume of turbostratic layered non-functionalized graphene aggregate 28 are not expected. The diffraction response of the composite is therefore consistent with preservation of the underlying layered carbon structure of the volume of turbostratic layered non-functionalized graphene aggregate 28 while the volume of turbostratic layered non-functionalized graphene aggregate 28 becomes dispersed within the volume of activated carbon 24 to form a mixed carbon network suitable for use within the first electrode layer 40 and the second electrode layer 48.

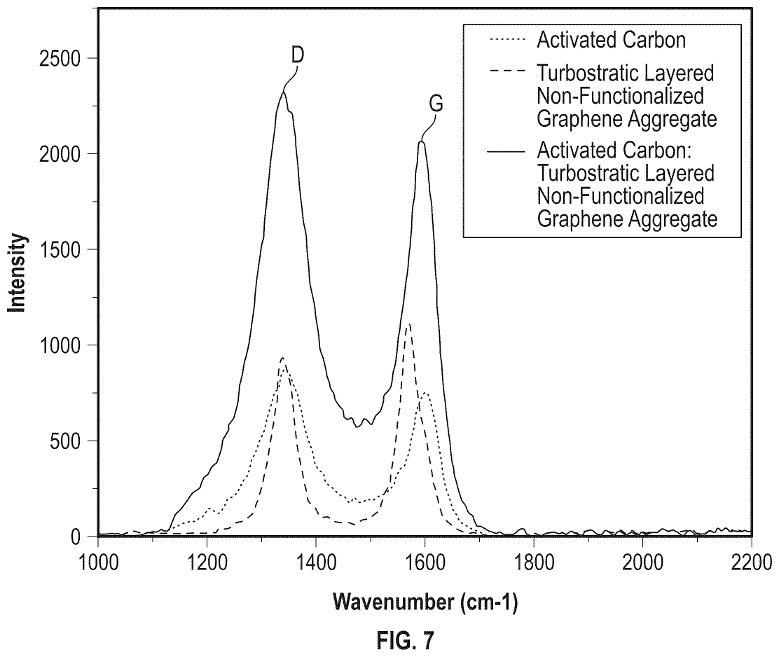

Referring now to FIG. 7, Raman spectra are illustrated for the volume of activated carbon 24, the volume of turbostratic layered non-functionalized graphene aggregate 28, and the composite formed by combining the volume of activated carbon 24 with the volume of turbostratic layered non-functionalized graphene aggregate 28. The spectra include a D band in a range of about 1330 to about 1340 inverse centimeters and a G band in a range of about 1570 to about 1600 inverse centimeters. The D band is associated with disorder in sp2-bonded carbon networks, including defect sites, edge sites, and disruptions in graphitic ordering, while the G band is characteristic of graphitic sp2-hybridized carbon and reflects in-plane vibrational modes of a sp2 carbon lattice. In this manner, the Raman response provides a spectroscopic indicator of a balance between ordered graphitic domains and disordered or defect-rich domains for each material and for the composite.

The ratio of intensities of the D band to the G band, expressed as ID/IG, provides a measure of structural disorder. The volume of activated carbon 24 exhibits an ID/IG of about 0.86, indicating a level of disorder consistent with activated carbon materials that include a mixture of microcrystalline graphitic domains and more disordered carbon regions associated with high porosity and heterogeneous carbon structure. The volume of turbostratic layered non-functionalized graphene aggregate 28 exhibits an ID/IG of about 1.19, indicating a higher defect concentration. This higher ID/IG behavior is consistent with turbostratic, nano-sized layered carbon in which a high density of edges, nanoscale domain boundaries, and rotational misalignment contributes to increased disorder signatures while retaining substantial sp2-bonded carbon character reflected by the G band. The composite formed by combining the volume of activated carbon 24 with the volume of turbostratic layered non-functionalized graphene aggregate 28 exhibits an ID/IG of about 0.93, which lies between the respective ID/IG values of the constituents. This intermediate ID/IG behavior is consistent with a mixed carbon network in which the Raman response reflects contributions from both the volume of activated carbon 24 and the volume of turbostratic layered non-functionalized graphene aggregate 28, supporting that the composite retains graphitic sp2 character while incorporating a controlled level of disorder associated with the combined microstructure.

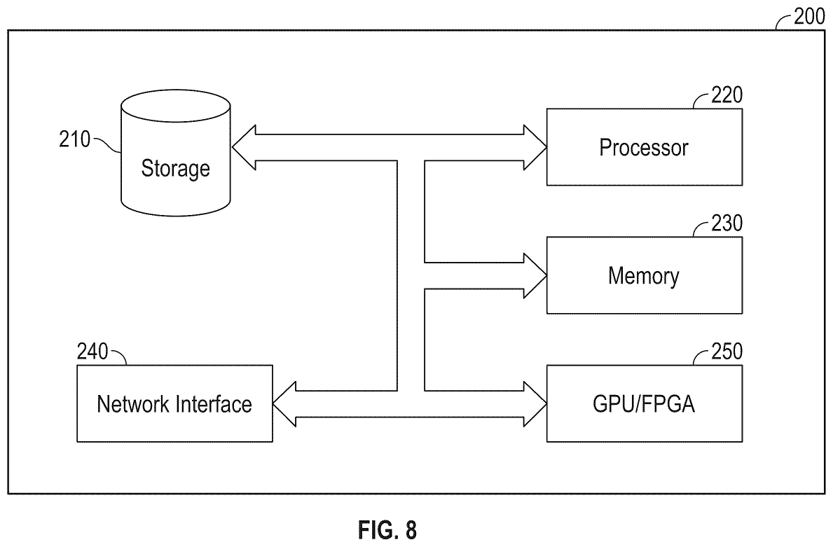

Referring to FIG. 8, a controller 200 is shown. The controller 200 is arranged to coordinate, regulate, and stabilize operation of the electrochemical energy storage system 10 during charge, discharge, monitoring, protection, and, when present, balancing across one or more cells or modules. The controller 200 may manage electrical conditions applied to the electrochemical energy storage system 10, supervise operating limits associated with voltage, current, and temperature, and coordinate measurement and reporting of system state. The controller 200 includes a storage unit 210, a processor 220, a memory 230, a network interface 240, and a GPU/FPGA 250. These elements cooperate to support deterministic control over charge and discharge profiles, real-time acquisition and analysis of measurement signals, and execution of protection actions that preserve device integrity and performance of the electrochemical energy storage system 10.

The storage unit 210 provides nonvolatile data retention for the controller 200. The storage unit 210 may hold firmware images and configuration bundles for the processor 220 and the GPU/FPGA 250, persistent logs of operating conditions such as current profiles, voltage trajectories, temperature histories, and event flags, and audit artifacts for traceability of manufacturing and field operation. The storage unit 210 may maintain structured datasets such as time-indexed records of equivalent series resistance estimates, capacitance estimates, leakage trends, and cycle counts derived from routine measurements, supporting drift analysis and predictive maintenance at the module level. In aspects, the storage unit 210 supports transactional updates so configuration changes, calibration tables, and threshold settings are atomically committed, reducing the likelihood of corrupted parameters following power interruption. The storage unit 210 may also retain configuration sets for different operating modes, including high pulse power mode, standby mode, transport and storage mode, and service mode, with each configuration set specifying limit thresholds and reporting intervals appropriate for the selected use case.

The processor 220 provides centralized computational control for the controller 200. The processor 220 may be implemented as a microprocessor, a digital signal processor, a central processing unit, a microcontroller, or another programmable logic device configured to execute embedded firmware or a real-time operating system. The processor 220 may orchestrate initialization routines, calibration routines, and closed-loop supervisory control, configure peripheral buses and direct-memory-access pathways for high-throughput data movement, supervise health monitoring and fault handling, and schedule deterministic tasks that manage measurement cadence and protection response times. The processor 220 may execute numerical routines that estimate state-of-charge proxies for the electrochemical energy storage system 10, compute capacitance from controlled current steps or pulse tests, estimate equivalent series resistance from transient response, and track self-discharge behavior from open-circuit voltage decay. The processor 220 may also manage operational policy decisions, such as limiting allowable current during high temperature events, reducing charge voltage under elevated temperature to reduce stress on the electrolyte 22, or applying controlled discharge sequences prior to maintenance. Interrupt service routines or dedicated real-time threads may handle low-latency events such as overvoltage detection, undervoltage detection, overcurrent detection, short-circuit detection, sudden temperature rise, or sensor fault detection, with response actions that may include opening contactors, commanding current reduction, or isolating a submodule.

The memory 230 is operatively connected to the processor 220 and provides program and data storage used during runtime. The memory 230 may include dynamic or static random-access memory reserved for time-critical buffers, lookup tables that linearize sensor responses, calibration matrices for temperature and voltage compensation, and state observers that store filtered estimates of current, voltage, and temperature. Executable images residing in the memory 230 may include low-level drivers for analog-to-digital converters, digital-to-analog converters, current shunt interfaces, Hall sensors, thermistor front ends, and isolation monitors, as well as deterministic task graphs defining a controller 200 timing topology. The memory 230 may further maintain circular buffers for raw and processed measurement frames, allowing continuous acquisition without data loss during transient bursts of computational load, and may maintain rolling statistics such as moving averages, peak tracking, and rate-of-change metrics used to trigger protective actions. In aspects, the memory 230 stores transient event snapshots that capture pre-fault and post-fault telemetry for later review, including voltage, current, and temperature traces with timestamps.

The network interface 240 provides connectivity between the controller 200 and external computational or supervisory systems. The network interface 240 may support wired or wireless links and may expose control and data endpoints for remote configuration, streaming telemetry, and integration into higher-level power management systems. The network interface 240 may support vehicle networks, industrial control networks, or embedded system interfaces, with examples including CAN, LIN, Ethernet, RS-485, or wireless links, depending on the installation environment. In operation, the network interface 240 supports remote dashboards that visualize voltage, current, temperature, and derived health indicators for the electrochemical energy storage system 10, initiates scripted diagnostic routines such as controlled pulse tests to estimate equivalent series resistance, and exchanges calibration bundles or parameter updates generated by external tools. The network interface 240 may also support secure synchronization of time bases with external references, allowing coordinated logging across multiple electrochemical energy storage system 10 units within a module or pack, and may support authentication and access control for configuration changes that affect safety limits.

The GPU/FPGA 250 is coupled to the processor 220 and supplies hardware-accelerated processing for tasks that benefit from massive parallelism or deterministic low-latency timing. In aspects, the GPU/FPGA 250 executes real-time digital signal-processing pipelines for high-rate sensor acquisition, including filtering of current and voltage waveforms, decimation and resampling for multi-rate telemetry, and event detection based on threshold and rate-of-change criteria. The GPU/FPGA 250 may execute low-latency estimators for equivalent series resistance and capacitance based on pulse response fitting, and may support fast-path protection logic where sensor measurement to action latency is constrained to microsecond-to-millisecond scales. Reconfigurable logic within the GPU/FPGA 250 may synthesize precisely shaped current demand profiles or test pulses for diagnostic routines when the controller 200 is integrated with external power electronics, and may compress or pre-process measurement data prior to transfer to the processor 220 or the network interface 240. In aspects, the GPU/FPGA 250 hosts parameterizable cores for automated characterization sweeps, including sequences that vary pulse amplitude and duration to map dynamic impedance across operating conditions.

The controller 200 may further include measurement and sensing subsystems (not shown) electrically coupled to the electrochemical energy storage system 10 and configured to acquire voltage, current, and temperature data used for monitoring and protection. Voltage sensing may include cell-level sensing, module-level sensing, or both, with high impedance dividers and isolation elements selected to preserve measurement accuracy and safety. Current sensing may be implemented with shunt resistors, Hall-effect sensors, or magnetoresistive sensors, with bandwidth selected to capture fast transients associated with pulse discharge and regenerative charge events. Temperature sensing may include sensors positioned near the electrochemical energy storage system 10 housing, near terminals, or near regions expected to heat during high current operation, with thermistors, resistance temperature detectors, or semiconductor sensors used depending on the application environment. The controller 200 may also coordinate with isolation monitoring elements, pressure indicators, or vent status indicators when the electrochemical energy storage system 10 is packaged with pressure management features.

The controller 200 may further include power interface elements (not shown) that regulate how the electrochemical energy storage system 10 couples to external circuitry. These elements may include contactors, solid-state switches, pre-charge circuits, fuses, or current-limiting elements, with control actions managed by the processor 220 and, for time-critical events, by the GPU/FPGA 250. In aspects, the controller 200 coordinates pre-charge and connect sequences to limit inrush current when the electrochemical energy storage system 10 is connected to a bus, and coordinates disconnect sequences to isolate the electrochemical energy storage system 10 under fault conditions. The controller 200 may also coordinate with external converters that execute constant-current, constant-voltage, or power-limited charge profiles appropriate for a supercapacitor duty cycle, including profiles that limit peak current based on temperature and state-of-health estimates.

During operation, the processor 220 executes control algorithms stored in the memory 230 to coordinate the above elements. A representative sequence includes validating configuration integrity from the storage unit 210, initializing sensor interfaces and verifying calibration tables, establishing a measurement cadence for voltage, current, and temperature signals, and arming event handlers that enforce safety limits. Thereafter, in response to commands received through the network interface 240 or local control inputs, the controller 200 supervises charge and discharge behavior of the electrochemical energy storage system 10, computes derived health indicators such as equivalent series resistance trend and capacitance trend, and records telemetry and events to the storage unit 210. The GPU/FPGA 250 may execute a fast path that filters and analyzes high-rate measurement streams and triggers immediate protective actions when thresholds are exceeded, while the processor 220 applies higher-level logic such as adaptive limit adjustment based on temperature and aging, scheduled diagnostic routines, and quality-of-service policies that allocate compute and memory resources to time-critical tasks.

Through these coordinated functions, the controller 200 maintains operational precision and protection for the electrochemical energy storage system 10. By integrating computational control in the processor 220, low-latency measurement processing and event handling in the GPU/FPGA 250, robust data retention in the storage unit 210, fast working memory in the memory 230, and reliable external connectivity via the network interface 240, the controller 200 supports repeatable high-power operation, consistent monitoring, and durable long-term cycling behavior of the electrochemical energy storage system 10 under demanding application conditions.

Certain aspects of the present disclosure may include some, all, or none of the above advantages and/or one or more other advantages readily apparent to those skilled in the art from the figures, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached figures are presented only to demonstrate certain examples of the disclosure. Other elements, steps, methods, and techniques that are insubstantially different from those described above and/or in the appended claims are also intended to be within the scope of the disclosure.

What is claimed is:

1. An electrochemical energy storage system, comprising:
a first electrode disposed on a first end of the electrochemical energy storage system;
a second electrode disposed on a second end of the electrochemical energy storage system opposing the first electrode;
a separator disposed between the first electrode and the second electrode; and
an electrolyte in ionic communication with the first electrode and the second electrode.

2. The electrochemical energy storage system of claim 1, wherein the electrochemical energy storage system is a supercapacitor.

3. The electrochemical energy storage system of claim 1, wherein the first electrode comprises a volume of activated carbon and a volume of turbostratic layered non-functionalized graphene.

4. The electrochemical energy storage system of claim 1, wherein the volume of turbostratic layered non-functionalized graphene comprises a volume of turbostratic layered non-functionalized graphene aggregate, and wherein the volume of turbostratic layered non-functionalized graphene aggregate is formed by an explosion or detonation process.

5. The electrochemical energy storage system of claim 4, wherein the explosion or detonation process is performed within a sealed constant-volume chamber.

6. The electrochemical energy storage system of claim 4, wherein the volume of turbostratic layered non-functionalized graphene aggregate has an elemental carbon purity of at least about 95 wt. %.

7. The electrochemical energy storage system of claim 4, wherein the volume of turbostratic layered non-functionalized graphene aggregate comprises sp2-bonded carbon.

8. The electrochemical energy storage system of claim 1, wherein the first electrode further comprises a polymer binder.

9. The electrochemical energy storage system of claim 8, wherein the polymer binder comprises polyvinylpyrrolidone, polyvinyl alcohol, or a combination thereof.

10. The electrochemical energy storage system of claim 1, wherein the electrolyte comprises a volume of tetraethylammonium tetrafluoroborate (TEABF4) in acetonitrile (ACN).

11. A method of forming an electrode for an electrochemical energy storage system, the method comprising:
mixing a volume of activated carbon and a volume of turbostratic layered non-functionalized graphene to form a mixture;
combining the mixture with a binder and a solvent to form a slurry; and
depositing the slurry on a current collector to form an electrode layer.

12. The method of claim 11, wherein the electrochemical energy storage system is a supercapacitor.

13. The method of claim 11, wherein the volume of turbostratic layered non-functionalized graphene comprises a volume of turbostratic layered non-functionalized graphene aggregate.

14. The method of claim 13, further comprising producing the volume of turbostratic layered non-functionalized graphene aggregate by an explosion or detonation process.

15. The method of claim 14, further comprising performing the explosion or detonation process within a sealed constant-volume chamber.

16. The method of claim 13, wherein the volume of turbostratic layered non-functionalized graphene aggregate has an elemental carbon purity of at least about 95 wt. % and comprises sp2-bonded carbon.

17. The method of claim 11, wherein the binder is a polymer binder.

18. The method of claim 17, wherein the polymer binder comprises polyvinylpyrrolidone, polyvinyl alcohol, or a combination thereof.

19. The method of claim 11, further comprising forming an electrolyte comprising a volume of tetraethylammonium tetrafluoroborate (TEABF₄) in acetonitrile (ACN).

20. An electrochemical energy storage system, comprising:
a first current collector;
a second current collector;
a first electrode disposed on the first current collector;
a second electrode disposed on the second current collector, wherein at least one of the first electrode and the second electrode comprises an electrode layer including a volume of activated carbon, a volume of polymer binder, and a volume of turbostratic layered non-functionalized graphene aggregate dispersed in the volume of activated carbon;
a separator disposed between the first electrode and the second electrode; and
an electrolyte comprising a volume of tetraethylammonium tetrafluoroborate (TEABF₄) in acetonitrile (ACN),
wherein the volume of turbostratic layered non-functionalized graphene aggregate is formed by explosion or detonation within a sealed constant-volume chamber,
wherein the volume of turbostratic layered non-functionalized graphene aggregate has an elemental carbon purity of at least about 95 wt. %, and
wherein the volume of turbostratic layered non-functionalized graphene aggregate comprises sp2-bonded carbon.
